(19) United States
(12) Patent Application Publication
(10) Pub. No.: US 2014/0259724 A1
(43) Pub. Date: Sep. 18, 2014

(54) Low Aspect Ratio Staged Closure Devices, Systems, and Methods for Freeze-Drying, Storing, Reconstituting, and Administering Lyophilized Plasma

(71) Applicant: HEMCON MEDICAL TECHNOLOGIES, INC., Tigard, OR (US)

(72) Inventors: Simon McCarthy, Portland, OR (US); Lisa Buckley, Portland, OR (US); Clint Pepper, Portland, OR (US); Ervelyn Winata, Portland, OR (US); Barry Starkman, Portland, OR (US)

(73) Assignee: HemCon Medical Technologies, Inc., Tigard, OR (US)

(21) Appl. No.: 13/801,523

(22) Filed: Mar. 13, 2013

(51) Int. Cl. F26B 5/06

(52) U.S. Cl. CPC F26B 5/06
USPC 34/284; 34/92

(57) ABSTRACT

The inventive device and methods described herein address the introduction of a safe and effective freeze-dried biological product, and particularly a plasma product, to a subject in need thereof. The present invention relates to a multifunctional, staged closure device, which also is described as a lyophilization container for plasma (LCP). The device and methods described herein address how to reproducibly achieve a low moisture and substantially oxygen-free atmosphere within a finally hermetically sealed biocompatible low aspect plastic vessel within a standard shelf-stoppering freeze dryer. The present inventive device and methods provide a freeze-dried plasma product that is fully traceable, preserves the constituent plasma activity, is readily prepared in a sterile fashion, is stable, ensures ease of storage and permits rapid reconstitution and delivery to a patient.

### BACKGROUND OF THE INVENTION

1. Field of the Invention

The inventive device and methods described herein address the introduction of a safe and effective freeze-dried biological product, and particularly a plasma product to a human or animal subject whose protein based clotting factors and inflammatory mediators have become compromised by injury, disease, or by use of anticoagulation therapy. The present inventive device and methods provide a freeze-dried plasma product that is fully traceable, preserves the constituent plasma activity, is readily prepared in a sterile fashion, is stable, ensures ease of storage and permits rapid reconstitution and delivery to a patient.

2. Description of Related Art

Plasma is substantially that part of single donor whole blood that is depleted in cellular components and is separated from whole blood in the presence of an anticoagulant such as citrate phosphate dextrose (CPD). One unit of single donor plasma is defined as the amount of plasma obtained from centrifugation of one unit of whole blood, and it may contain from 180 to 300 mL of plasma. One unit of single donor plasma for transfusion is designated in the U.S. and many other countries by the term Fresh Frozen Plasma (FFP) (“Circular of Information for the Use of Human Blood and Blood Components” available at: https://www.aabb.org/resources/bct/Pages/aabb_coi.aspx#blood (last accessed Mar. 13, 2013). FFP is fully traceable through its International Society of Blood Transfusion (ISBT) Code 128 barcode labeling from donor to recipient. FFP is that plasma component of blood placed in a standard blood bag within 8 hours of collection and rapidly frozen (to ≦−18° C.) for storage for up to 12 months. The processing and storage control in preparation of FFP substantially preserves the proteins present within the plasma (Steil, L., et al., Transfusion 48:2356 (2008)). As a transfused product, FFP primarily serves as a source of coagulation factors and is indicated in the management of coagulopathies associated with liver disease, warfarin therapy, disseminated intra-vascular coagulation, massive transfusion, and congenital factor deficiencies (Liumbruno, G., et al., Blood Transfus. 7:132 (2009)). When required, the frozen FFP is thawed by heating with the aid of a water bath at 37° C. The standard thawing procedure for a unit of FFP using a water bath is reported to take between 17 and 30 minutes. See Churchill, W. H., et al., Am. J. Clinical Pathology 97:227 (1992); Goodnough, L. T., A.s.B. Centers 1-2 (2012). Plasma is 90-93% w/w water and 6% to 8.5% w/w protein with a small residual of lipids, hormones, nitrogenous waste, dissolved gases and various sodium and potassium electrolytes. Recent proteomic investigations estimate that human plasma contains close to 4,590 proteins (Shen, Y., et al., Proteomics 5:4034 (2005)) of which only 5% are the “classic proteins” associated with the coagulation cascade. The remaining proteins are associated with cellular leakage, cytokine, membrane and immunoglobulin functions. Depending on the extent of separation from its cellular component, there may be a small residual fraction of lysed red blood cells (RBCs) and platelets in the frozen plasma.

FFP transfusion in the United States in 2008 was close to two and a half million units in the emergency and operating room setting (Whitaker, B. I., et al., US Dept Health Human Services: The 2009 national blood collection and utilization survey report, (2009)). Nearly two million units of a 24 hour fresh frozen plasma product PF24 was used in 2008, although this product with its delayed freezing does not preserve the clotting factors as well as FFP and its Protein-S anticlotting factor is significantly reduced (Committee, B.P.A., Center for Biologics Evaluation and Research Meeting #102: Topic II: Evaluation of Possible New Plasma Products Following In-Process Storage at Room Temperature for up to 24 Hours, in Blood Products Advisory Committee (2012)).

The other components separated from whole blood are the cellular components of packed RBCs and platelets (Puget Sound Blood Center: Blood Components Reference Manual—Section D: Pt III. Fresh Frozen Plasma (2005)). These cellular components generally cannot be frozen for long-term storage. For example, platelets must be stored at 22° C. and used within five days, and RBCs must be stored at a temperature between 1-6° C. and used within 42 days.

Currently, early delivery of thawed or dried plasma to individuals with serious pre-hospital injury is not the standard of care in the U.S. Although original resuscitation therapy was based on plasma transfusion, concern regarding risks associated with blood product transfusion has resulted in present civilian resuscitation therapy relying on crystalloid or colloid volume expanders. See Cope, O. and F. D. Moore, Annals Surgery 126:1010 (1947); Kendrick, B. G. D., The Plasma Program—Office of the Surgeon General 265-323 (1964). These volume expanders are unable to reverse coagulopathy and they promote serious hemodilution in individuals with significant blood loss.

During World War II, plasma resuscitation therapy was so widely acknowledged as effective in treating soldiers with serious injury that a freeze-dried product was developed as part of the United States' war effort in 1941 (Id.). This product was prepared in stoppered glass bottles, the freeze-dried plasma was sourced from a large volume plasma pool (up to 1,000 units from different individual donors); a mercurial preservative (thimerosal or phenylmercuric borate) was added; the plasma was frozen outside the freeze dryer by rotation of the bottle in an alcohol dry ice bath (shell freezing technique) at between −50° C. and −60° C.; the plasma was freeze-dried to a moisture content of less than 1%; and it was required to be soluble within 10 minutes when reconstituted to its original volume. The freeze-dried plasma was reconstituted with a solution of 0.1% citric acid solution instead of water since it was found that “the pH of 7.4-7.6 thus secured preserved much of the complement and prothrombin, labile elements which were lost in considerable amounts on storage” (Id.). It was also found that a citric acid solution with a pH of 2.8 kept much better in glass than did distilled water. Accordingly, it was recommended on Dec. 15, 1942, that 0.1% citric acid solution be substituted for 1.0% sodium chloride in the reconstitution of dried plasma (Id.).

Between the start of the program in 1941 and the end of the war in 1945, over 10 million units of freeze-dried plasma were prepared and distributed to the U.S. military by involvement of at least eight large United States pharmaceutical companies (Id.). However, wide pooling of the fresh plasma resulted in contamination of the pools. There was a high incidence of jaundice among plasma recipients. Symptoms included yellowing of the skin and eyes. Soon after introduction of the pooled freeze-dried plasma in 1941, there were a number of deaths attributed to jaundice. In 1942, 28,000 military personnel, injected with a yellow fever vaccine prepared with pooled human blood serum (plasma without fibrinogen) as a stabilizing agent, developed jaundice (McDonald, S., US FDA Center for Biologics Eval and Research 1-40 (2002)). Of these 28,000 military personnel, one hundred died. Jaundice was found to result from infection by the Hepatitis B virus (HBV) (Gocke, D. and N. Kavey, The Lancet 293:1055 (1969)). In 1952, wide pooling of fresh plasma for infusion was discontinued due to the problem of infection of pooled blood by HBV (Kendrick, supra 714-810). This discontinuation in the practice of plasma pooling effectively stopped the freeze-dried plasma program.

Since the mid-1980s, improvements in blood testing and screening have significantly enhanced blood product transfusion safety in the United States. The present high safety record (generally on the order of 1/1,000,000 or less incidence of pathogenic viral transmission) in the use of single donor FFP in the United States can be attributed to the blood testing and screening measures introduced from 1985 onwards, and their continued improvement. While various pathogen inactivation/reduction approaches are being evaluated for further safeguarding the United States blood supply, risk/benefit and cost/benefit analyses have concluded that the current approach of screening and testing of single donor blood remains a proven and effective safeguard. See Whitaker, B. I., et al., supra; US FDA, Fatalities Reported to FDA Following Blood Collection and Transfusion: Annual Summary for Fiscal Year 2011; Perkins, H. A. and M. P. Busch, Transfusion 50:2080 (2010); Leach Bennett, J., et al., Transfusion Medicine Reviews 25:267 (2011).

Pathogen inactivation/reduction approaches have been shown to reduce the activity of coagulation and anti-coagulation factors. See Rock, G., Vox Sanguinis 100:169 (2011); Sandler, S. G., Transfusion Apheresis Sci. 43:393 (2010). Four approaches have been considered for viral inactivation/reduction of plasma outside the standard treatments of heat, pH change, and filtration. These proposed pathogen inactivation/reduction treatment approaches include solvent detergent, methylene blue, amotosalen, and riboflavin (Rock, supra). Use of ultraviolet irradiation is necessary in the case of the latter three treatments. The solvent/detergent pathogen inactivation process is effective against enveloped viruses such as Hepatitis A virus (HAV), Human immunodeficiency virus (HIV), as well as Hepatitis C virus (HCV), but is ineffective against non-enveloped viruses such as Parvovirus B19. The solvent detergent treatment significantly lowers the activity of Protein S (−44%) and antiplasmin (−79%) with lower levels of reduction in the coagulation factors Fibrinogen, Factor V, Factor VIII, Factor XI (−16%, −37%, −22%, and −5%, respectively) (see Rock, supra); an imbalance that could promote thromboembolism at high dosing of plasma transfused with this treatment. See Committee, B.P.A., supra. Such high dosing is normally expected in the case of traumatic injury and high blood loss for which freeze-dried plasma is targeted. The interaction of methylene blue and amotosalen produce reactive bi-products that must be removed while the riboflavin process constitutes a single step without the need for reactive product extraction.

Since its informal withdrawal in the early 1950s, barriers to freeze-dried plasma re-introduction in the United States have included: (i) the medical community's preference for crystalloid and colloid resuscitation fluids without acknowledgement of the benefits of the factors present in plasma; (ii) lack of serious review of plasma alternatives to wide pooled plasma; (iii) concern regarding viral and non-viral risks associated with transfusion of plasma (MacLennan, S. and J. A. J. Barbara, Best Practice and Res. Clin. Haematology 19:169 (2006)); (iv) the lack of innovation regarding preparation of freeze-dried plasma using modern freeze dryer processing without adversely affecting plasma proteins and without introducing contaminants; and (v) stringent United States regulatory standards for new blood products in the modern biologic era.

As indicated by a South African Medical Journal article in 1976, single donor lyophilized plasma (sourced from expired blood) and lyophilized plasma from single donor FFP (sourced from fresh blood with all the clotting factors preserved) were considered for resuscitation uses as volume expanders 36 years ago. See White, J. A. M., S. Afr. Med. J. 1675-1683 (1976). However, this use of plasma, especially dried plasma, was primarily associated with its desirable osmolality and there was little recognition of possible desirable properties associated with the plasma proteins. Because albumin demonstrated a similar osmolality to plasma but could be virally inactivated by pasteurization, it became the preferred resuscitation agent and plasma's use in resuscitation not only became forgotten but was also contraindicated.

In 1986, Traverso et al. (Traverso, L. W., et al., J. Trauma 26:176 (1986)) published a swine injury study that demonstrated resuscitation following large blood loss using either whole blood or fresh plasma provided significant survival advantages over saline or albumin. In 1987, the National Red Cross Blood Center in Thailand reported on successful clinical trials of a single donor plasma freeze-dried product from FFP (Isarangkura, P. B., et al., Ric. Clin. Lab 17:349 (1987)). In 1991, Trobisch reported on the problematic development of freeze-dried plasma by the West German Red Cross using newly developed virally inactivated solvent detergent plasma (Trobisch, H., Beitr Infusionsther 28:92 (1991)). In 1996, Benefice and Escarment described the development of a freeze-dried plasma product for the French Army (Benefice, S. and J. Escarment, Ann Fr Anesth Reanim 15:101 (1996)). In 2006, the United States Army explored development of a solvent detergent freeze-dried plasma product with the West German Red Cross (GRC), however, the GRC was not interested in seeking regulatory approval in the United States. See Barrows, E., Defence ATandL, 16-19 (2006); Jenkins, D., et al., T.D.H. Board (2011). In early 2008, HemCon Medical Technologies, Inc. (“HemCon”) was the sole successful applicant in response to a 2007 Request for Proposal from the United States Army for development of a freeze-dried plasma product (Jenkins, supra). Later in 2008, the West German Red Cross introduced a single donor plasma freeze-dried product in a stoppered glass bottle that was approved by the German regulatory authority based on pre-clinical data.

In September of 2008, Borgman et al. (Borgman, M. A., et al., J. Trauma 63:805 (2007)) published a retrospective study, providing evidence that increased volume ratio of plasma to RBCs from 1:8 to 1:1 significantly increases survival in massive transfusion. Currently, both the French and German armies field freeze-dried plasma products in the war in Afghanistan (Operation Enduring Freedom). Both of these products are contained in glass bottles that are closed by stoppering using standard rubber stoppers at the conclusion of freeze-drying inside a freeze dryer. The French product contains plasma prepared from small pools of amotosalen virally inactivated plasma. The German product contains single donor plasma.

There remains a large unmet need for an improved multifunctional plasma lyophilization device that enables the preparation, storage, transport, and delivery of safe and effective plasma for administration to individuals in need.

### BRIEF SUMMARY OF THE INVENTION

The device and methods described herein address provision of safe and effective freeze-dried biological products, including single donor plasma products prepared from FFP. The present invention advantageously provides a container and process that enables: a potential zero incidence of transfusion related acute lung injury (TRALI) (Arinsburg, S. A., et al., Transfusion 52:946 (2012)); the potential for non-Typed “universal” delivery; good retention of coagulation factors (≧90%); >99.999% confidence in preservation of sterile properties and avoidance of cross-contamination during processing and storage; the ability to field the product in either civilian or military applications; the ability to pack the product in an individual first aid kit; the durability to withstand rough use; a design permitting full traceability from donor to recipient; a long-life shelf storage (≧2 years' time at 2-8° C.) and good shelf storage (≧1 year) at room temperature (20° C.-25° C.); preservation of system sterility on spiking attachment of a reconstitution fluid and administration set; production of a plasma cake having a high specific surface area, preferably in the range of about 0.05 to 10 m²/g, for lyophilized product (from Rambhatla et al., AAPS PharmSciTech 2004; 5 (4) Article 58, http://www.aapspharmscitech.org); reproducibly rapid reconstitution of the product to its fully soluble form near pH 7.4 in less than 2 minutes; and the ability to add or remove liquid material aseptically by hypodermic syringe through a separate injection port. The handling and containment of the single donor lyophilized plasma described herein, from its transfer into a unique lyophilization container for plasma (LCP) to its administration by transfusion, involves a number of innovative container features.

The present inventors have developed a multifunctional, staged closure device, which also is described as a lyophilization container for plasma (LCP). The device together with the methods to manufacture, preserve, and deliver a safe and effective freeze-dried plasma product comprise the main inventions presently disclosed.

The device and methods described herein address how to reproducibly achieve a low moisture (equal to or less than 1% w/w) and substantially oxygen-free (at least less than about 100 ppm O₂, preferably at least less than about 10 ppm O₂, more preferably at least less than about 1 ppm O₂, still more preferably less than about 100 ppb O₂, and most preferably less than about 10 ppb O₂) atmosphere within a finally hermetically sealed biocompatible low aspect plastic vessel within a standard shelf-stoppering freeze dryer. In a preferred embodiment of the invention the substantially oxygen-free air environment achieved within the closed device is less than about 1 ppm O₂. The vessel of the present invention is not a plastic or glass vial or a plastic or glass bottle, has a ratio of open (with regard to gas flow and covered by a semi-permeable membrane) top face surface area during freeze-drying to be later closed (to gas flow) equal to or greater than 1:10 of the vessel's overall external surface area, and an aspect ratio as seated in a freeze dryer of height vs. length or height vs. width of not more than 1:3 and sealing that is achieved without the forceful placement and close fitting of a rubber stopper within a neck. The reproducible hermetic sealing within a freeze dryer, of a plastic molded vessel having height vs. length or height vs. width aspect ratio of not more than 1:3, and weighing less than 150 grams empty as assembled, presents a complex problem since, even with good alignment between parts, the smallest amount of flexure in the vessel or in the seating of the hermetic sealing system will open the seal and allow entry of deleterious moisture and oxygen.

Moisture can degrade the stability of freeze-dried plasma both by direct hydrolytic degradation of proteins and also by lowering (plasticizing) the glass transition temperature (Tg) of the plasma cake such that there is sufficient protein conformational mobility for reaction in the cake. Substantial initial oxygen exclusion (to less than about 1 ppm O₂) from the freeze-dried cake is important for shelf life stability since oxygen reacts readily with organic molecules to form labile peroxy species that propagate degradation processes.

Reliable and reproducible minimization of water (preferably equal to or less than 1% w/w) and substantial initial exclusion of oxygen (to less than about 1 ppm O₂) from the freeze-dried plasma cake, and particularly from a freeze-dried plasma cake having a high specific surface area (preferably about 0.05 to 10 m²/g), is highly desirable to achieve extended shelf storage of freeze-dried proteins (Wang, W., Int J Pharm 203:1 (2000)). This invention advantageously and newly provides for a low aspect ratio container (having an aspect ratio of not more than 1:3 height vs. length or height vs. width) with semi-permeable membrane sterile integrity that provides for and demonstrates acceptable minimization of water content (preferably equal to or less than 1% w/w) and allows for initial substantial oxygen exclusion (to less than about 1 ppm O₂).

The device and methods described herein address how to achieve a high level of assurance (≧99.999%) in the antimicrobial filtration efficiency in the semi-permeable membrane vent and its integral attachment in the top surface of the device whose surface area is equal to or greater than 0.10 of the overall external surface area of the device. Such a requirement is essential in the case of the device when manufacturing under preferable non-sterile clean room environments. Previously described lyophilization containers with semi-permeable membranes and the processes used with these containers cannot be controlled to the necessary high level of assurance to be acceptable for processing, storing, reconstituting and administering a transfusable blood product. The following description of the device, its method of non-destruction validation, its method of sterile filling, its labeling, its method of freezing, its method of freeze-drying, its method of closure, its method of validation of closure, its packaging, its storage, its reconstitution and its administration provide for a device and a methods which allows an acceptably high level of assurance (>99.999%) of integrity. See Bergmann, T. and H. Brustmann, Process and Container for Freeze-drying under Sterile Conditions (1992); Henigan, L. F. X., et al., Lyophilization Container (1999); Tamari, Y., Container for Lyophilizing Biological Products (2003); Tamari, Y., Container for Biological Products Requiring Cellular Stasis (2004); Zukor, K. S., et al., Lyophilization Container (1999). The device and methods described herein address how to prepare a uniformly vertical, open, freeze-dried plasma cake structure that dries in a highly efficient manner and that can be reconstituted preferably in under two minutes and most preferably in under one minute. Preferably, the frozen plasma cake of not more than 250 g is not more than 0.8 inches thick since thinner freeze-dried cakes dry and reconstitute more quickly. Accordingly, a container with a low aspect ratio of height to base surface area is preferred. The device aspect ratio would be one of height vs. length or height vs. width of not more than 1:3.

The device and methods described herein address how to ensure retention to a high degree of confidence (>99.999%) of the plasma protein mass within the device during primary drying, when there can be a high rate of water vapor outgassing during sublimation. In a device (such as an open and/or partially stoppered bottle) that is not closed to the exterior, such outgassing can cause partial loss of solid protein residue out of the container during freeze-drying. In the case of freeze-drying of multiple lots of single donor plasma (ranging in weight from 180 g to 230 g) inside the same freeze dryer, not only is escape of the plasma protein residue undesirable with regard to potential exposure to operators, but it also problematically gives rise to the potential for multiple co-mingling of plasma protein residue between different lots of the single donor plasma. That is, stoppered partially open bottles containing multiple lots of single donor plasma processed inside the same freeze dryer can result in the dangerous cross-contamination of the freeze-dried materials.

The device and methods described herein address how to ensure retention of the reconstituted freeze-dried plasma in the device without any permeation of the reconstituted plasma or the reconstitution fluid through the device's semi-permeable membrane surface. The semi-permeable membrane surface is equal to or greater than 0.10 of the total surface area of the device. The semi-permeable membrane is able to retain the reconstituted plasma and reconstitution fluid when the pressure on the internal side of the semi-permeable membrane of the device is 150 cm H₂O, or more than the pressure on the external side of the semi-permeable membrane of the device.

The device and methods described herein include how to transfer single donor plasma sterilely into the device for freeze-drying.

The device and methods described herein include how to transfer reconstitution fluid aseptically into the closed device by using a twist-off, double-septum, sealed spike port. In one embodiment, the device and methods described herein include the transfer of reconstitution fluid aseptically into the closed device by using a single septum spike port.

The methods described herein include how to transfer and administer reconstitution fluid aseptically into the closed device by using a twist-off, double-septum, sealed spike port and an administration set. In one embodiment, the device and methods described herein include the transfer and administration of reconstitution fluid aseptically into the closed device by using a single septum spike port.

The methods described herein include how to package for storage, reconstitute and administer freeze-dried plasma so that it remains effective and safe for at least three years at 2-8° C. and at least one year at room temperature (20° C.-25° C.).

Embodiments of a multifunctional staged closure device of the present invention can be used for freezing, freeze-drying, storing, reconstituting, and administering a material, such as plasma. The device is sized and configured such that it may comprise the following features: remain rigid in the temperature range −50° C. to 80° C.; remain intact over the temperature range −50° C. to 80° C.; allow 100% non-destructive testing and assurance of its semipermeable membrane closure system; sterilely receive the material; accept regulatory sized labeling for required ISBT Code 128 traceability of a single donor blood product from donor to recipient at all stages of handling; allow for uniformly vertical ice formation while it undergoes freezing on a freeze dryer shelf; provide for uniform shelf heating and rapid loss of sublimated ice vapor during freeze-drying; provide for a high level of closure integrity that ensures maintenance of material containment and also of exclusion of external contaminants; maintain dryness of its interior at the conclusion of freeze-drying within a stoppering freeze dryer and to prevent atmospheric contamination on opening of the freeze dryer; allow for non-destructive testing and assurance of its hermetic sealing closure system; allow it to be placed securely within a secondary closure (long term packaging) system to ensure long-term closure to potential atmospheric contaminants and absence of exposure to light; and serve as a vessel from which the freeze-dried material, after being reconstituted, can be delivered to an individual in a safe and aseptic manner. Uniform vertical ice freezing allows for rapid sublimation of ice during freeze-drying and also for rapid reconstitution of the freeze-dried product.

The device within its secondary closure system is sized and configured to maintain its integrity and the integrity of its contents through rough handling that may be experienced in a first responder's individual first aid kit; to allow for minimal space usage within a first responder's individual first aid kit; to serve as the containment for the freeze-dried material while it undergoes transport, handling, and storage prior to its administration or delivery; and to allow simple removal of the device from its secondary closure system to allow the freeze-dried material to be reconstituted.

Using the multifunctional device, plasma can be securely contained, sterilely transferred, labeled for traceability and chain of custody, uniformly frozen, efficiently freeze-dried with minimal chemical constituent change, sealed closed, packaged, transported, readily stored with minimal chemical constituent change, easily removed from packaging, rapidly reconstituted, and aseptically administered from a single vessel.

The multifunctional staged closure device includes features that provide distinct and innovative advantages. The device may be used for preparation of various biological products, including any blood products, etc. The device provides for a closed system including the staged closure of a sterile multifunctional vessel wherein sterility of the material that is frozen, freeze-dried, transported, stored, reconstituted, and administered in a single vessel is maintained. The device includes a gas impermeable rigid lid that is a movable and a connected component of the device. The gas impermeable rigid lid is positioned in a first position so as to protect, by shielding, a gas permeable membrane sealed on the vessel, yet the lid also permits the freeze-drying of material within the device by providing air access to and vapor transmission from the material being freeze-dried. The gas impermeable rigid lid is then moved into a secured and fixed second position that seals and protects the freeze-dried material within the device. The device is shaped so that its administration port occupies a fluid release point ensuring minimal hold-up of reconstituted freeze-dried material when the device is positioned for the administration of reconstituted freeze-dried material to a subject. The device may include a hanger that assists in mounting the device for administration of reconstituted freeze-dried material to a subject. The device preferably comprises three ports for 1) the introduction of material to be freeze-dried, 2) reconstitution of the freeze-dried material, and 3) administration of the reconstituted freeze-dried material, respectively. These three ports are advantageously located in a raised position relative to the bottom surface of the device when the material to be freeze-dried is introduced and subsequently freeze-dried, such that the ports do not interrupt the freezing of the material to be freeze-dried, or inadvertently cause non-uniformity in the freeze-dried material by interfering in the process of uniform vertical freezing. As described in greater detail below, the tubing, preferably polyvinyl chloride (PVC), used to supply materials into the device, the reconstitution port, and the administration port, are each designed to ensure the effectiveness, sterility, durability, and ease of use of the device. Due to the unique features of the device, potential contamination issues are effectively controlled during processing and storage because the device provides for a system that is closed to external contamination and prevents the contents of the device from escaping.

### BRIEF DESCRIPTION OF THE FIGURES

The accompanying Figures, which are incorporated in and constitute a part of this specification, illustrate various exemplary embodiments.

FIG. 1. Composite perspective drawing of a device 100 including: two stage closure lid; gasket incorporated inside inner surface of container lid; container frame body including filling (right hand side) and administration (left hand side) ports; polyvinylchloride (PVC) sterile connection plasma filling tubing to be sealed at right hand side with a Barblock™ on left hand side able to be securely connected to container frame barb filling port, semipermeable membrane able to be sealed to top peripheral surface inside container, clear impermeable flexible thin film to be sealed to peripheral flat edging at base of container frame.

FIG. 2. Perspective drawing of assembled device 100 without a lid.

FIGS. 3A and 3B. Perspective drawings of assembled device 100 with a lid demonstrating the first stop partial closure of the container lid on the container frame, and the second and final stop full closure of the container lid on the container frame.

FIGS. 4A and B. Plan view of the first stop partial closure of the container lid on the container frame of device 100, and the second and final stop full closure demonstrating the full hermetic closure of device 100 with ×2.5 and ×5 close-up views of the closure system.

FIGS. 5A-C. Plan views of device 100 container frame, as shown from the top, end, and side.

FIGS. 6A-G. Views of device 100 container lid, as shown from the top, end, side, bottom, end transverse sectional, side transverse sectional, and exploded detail of gasket mounting on inside surface of the lid.

FIG. 7. Plan view of preferred angular alignments of device 100 lid 103 and the device 100 frame wall 104 with the planar alignments of lid top, frame top (first broad surface) and frame bottom (second broad surface).

FIG. 8. Plan view of filling a labeled device 100 with plasma from sterilely connected FFP plasma bag.

FIG. 9. Plan view of attachment of reconstitution fluid bag to device 100 to allow aseptic filling with reconstitution fluid.

FIG. 10. Plan view of administration of reconstituted plasma from device 100.

FIG. 11. Perspective drawing of hermetically closed device 100 with aseptic hypodermic needle septum port at one end of device 100.

FIG. 12. Perspective view of device 100 heat-sealed within a gas impermeable foil pouch for storage after lyophilization and before reconstitution to liquid plasma.

FIGS. 13A and B. Plan views of fully closed device 100 with pull-off tab and small diameter hole through lid to allow for expulsion of internal gas on reconstitution and for entry of filtered gas on administration.

FIG. 14. Plan view of alternate first stop partial closure of device 100 involving a raised base frame lip with a second slot.

FIG. 15. Plan view of alternate placement of reconstitution fluid/administration spike port septums against device 100 frame wall inside surface.

FIG. 16. Plan view of alternate placement of reconstitution fluid/administration spike port septums against device 100 frame wall inside surface and reduced height of device 100.

FIG. 17. Plan view of gas permeable membrane supported within a rigid frame support prior to attachment to device 100. The semipermeable membrane is pre-attached within a rigid frame support which may be formed from a polypropylene material.

FIG. 18. Composite perspective drawing of alternate device 100 container including: container two stage closure lid; container gasket incorporated inside inner surface of container lid; container frame body including filling (right hand side) and administration (left hand side) ports; polyvinylchloride sterile connection plasma filling tubing; semipermeable membrane able to be sealed to top peripheral surface inside container; clear impermeable flexible thin film able to be sealed to peripheral flat edging at base of container frame.

FIGS. 19A and B. Perspective drawing of fully assembled alternate device 100 demonstrating first stop partial closure of the container lid on the container frame, and the second and final stop full closure of the container lid on the container frame.

FIGS. 20A-C. Plan views of alternate device 100 container frame, from top, side, and bottom.

FIGS. 21A and B. Plan views of alternate device 100 container lid from side and side end.

FIGS. 22A and B. Exploded detail views of the first stop partial closure of the alternate device 100 depicted in FIG. 19A, and the second stop full hermetic closure of alternate device 100 depicted in FIG. 19B.

FIGS. 23A-C. Top plan and side elevation views of the non-destructive assurance testing apparatus for the semipermeable membrane and semipermeable membrane attachment/sealing to device 100 without the lid. The apparatus is used for partial membrane wetting and testing by pressure flow methods.

FIGS. 24A-24I. Stability test results of lyophilized plasma prepared in a device 100 (Phase I clinical container), fully stoppered, packaged in secondary foil packaging and stored at controlled temperature conditions of either 2° C.-8° C. or 23° C. (RT) for 0, 2, 4, 6, 9, 12, 19, 24, and 36 months. Each time point for 2° C.-8° C. is an average of measurements taken from 13 different FFP units in 13 different packaged device 100 containers. Each time point for 23° C. is an average of measurements taken from three different FFP units in three different packaged devices 100. Error bars in FIGS. 24A-24I represent a standard deviation. Individual testing at the different time points for both temperature conditions as shown in FIGS. 24A-24I was performed for A) % w/w residual moisture in the lyophilized plasma; B) Prothrombin time (PT); C) Partial thromboplastin time (aPTT); D) Factor V % activity; E) Factor VIII % activity, F) Factor VIIa % activity, G) Protein S % activity; H) Antithrombin III % activity; and I) Total Protein (g/dL). Tables 8A and 8B tabulate the FIGS. 24A-24I stability data results (DB PT=Prothrombin time; AT=Antithrombin III) as well as additional data results for pH, osmolality, INR (DB INR), fibrinogen (FB), D-Dimes, and Prothrombin Fragment (PF 1.2).

FIGS. 25A-B. Photographic images looking directly inside of a Virtis 24 sqft CIP/SIP lyophilizer compartment 300 with the front door (not shown) open to show 2′×3′ freeze dryer shelves (top loading shelf 311, bottom shelf 314, and shelves in a collapsed configuration 310) shown oriented one on top of another and with four filled devices 100 shown in either partial closure 100v or full closure 100w configurations while sitting on a flat surface of a top loading freeze dryer shelf 311. FIG. 25A shows a pneumatic ram arm 301 and ram closure plate 302a sitting spaced away from four filled and partially closed device 100 containers in first position of partial closure 100v on the top loading freeze dryer shelf 311. All four devices 100 in their partially closed and filled with clear thawed FFP plasma configuration are identified here by reference identifier 100v. FIG. 25B shows a pneumatic ram arm 301 and ram closure plate 302b stopped hard onto the filled and now fully closed device 100 containers in second position of full closure 100w in their final position of full closure on the top loading freeze dryer shelf 311. As depicted in FIG. 25B, all four devices 100, are fully closed and filled with freeze dried plasma (opaque material) inside the device 100.

### DETAILED DESCRIPTION OF THE INVENTION

Although the disclosure hereof is detailed and exact to enable those skilled in the art to practice the invention, the physical embodiments herein disclosed merely exemplify the invention that may be embodied in other specific structures. Elements common between figures may retain the same numerical designation.

As shown in exploded views of FIG. 1, the device 100 comprises a vessel made of several components having different physical properties to thereby serve different functions. As shown, the vessel includes a frame 101 that peripherally encircles an interior space 102. The vessel also includes a rigid lid 103, cross members 115, and a gas permeable membrane 105 affixed to the internal upper skirt rim area 119 on the inside of frame 101 and an impermeable base film 106 affixed to the outward peripheral base rim 120 on bottom of the frame 101. The interior space 102 is bounded by, and enclosed by, the frame 101 (with the lid 103), cross members 115, and gas permeable membrane 105 components on a first broad side 150 of the frame 101, and the impermeable base film 106 on a second broad side 160 of the frame 101.

The device 100 has sufficient rigidity and structural integrity to allow for staged closure during freeze-drying, as well as handling in austere environments and pre-hospital first aid kits. Device 100 and its components are resistant to breakage during freeze-drying and subsequent handling.

Assembled into device 100, the various components form a multifunctional staged closure device in which a material can be sterilely transferred, kept isolated from potential microbial and particulate contaminants, labeled, frozen, freeze-dried, hermetically closed to isolate material from potential gaseous contaminants, stored, reconstituted, and administered parenterally as a substantially unchanged reconstituted liquid. During sterile transfer, labeling, freezing and freeze-drying, device 100 maintains its partial lid closure configuration (as shown in FIG. 4A). Immediately after freeze-drying with equilibration to atmospheric pressure with inert gas within the freeze dryer, and before opening of the freeze dryer, a fully closed, hermetically sealed configuration of device 100 (FIGS. 3B and 4B) is achieved in the controlled environment of the freeze dryer using the freeze dryer stoppering system. Hermetic closure within the freeze dryer ensures that the undesirable atmospheric contaminants of water and oxygen do not enter the container and compromise the material stability of the enclosed dried material on opening the freeze dryer to atmosphere. Any delay in hermetic closure of the system until outside of the freeze dryer is highly undesirable since, for example, the freeze-dried plasma cake comprises a high porosity high specific surface area that readily adsorbs and reacts with atmospheric oxygen and water. The hermetically sealed system provides highly reliable protection against atmospheric contamination at the conclusion of freeze-drying, and in combination with a final packaging system, provides for an inert dry environment ensuring material stability over long term storage.

Sterile transfer is achieved by sterile connection between the transfer tube of a thawed material, such as thawed FFP, to the similar PVC transfer tubing 116 attached to the device 100 (as shown in FIG. 8) and separation by heat sealing of the PVC transfer tubing 116 near to device 100's filling port 109. After filling of device 100, it is transferred to a freeze dryer for freezing and freeze-drying of the material. Once the material has reached suitable dryness, the lid 103 is closed onto the external inward peripheral rim 121 of the first broad side 150 to uniformly contact gasket 114, and hermetic closure is achieved. The closed device and its freeze-dried contents are removed from the freeze dryer and placed in secondary closure packaging. In its secondary closure packaging (as shown, for example, in FIG. 12), the freeze-dried material may be transported and stored. On removal from its secondary packaging, the device 100 may be aseptically connected at its top reconstitution fluid port 107 to a reconstitution fluid bag and reconstitution fluid added to device 100 to effect reconstitution (as depicted in FIG. 9). Following reconstitution, an intravenous administration line may be connected to the administration port 108 and the reconstituted material administered to a patient (as depicted in FIG. 10).

A. Multifunctional Staged Closure Device Components

Components of the device 100 comprise different materials appropriate to serve their respective functions. The technical features and configurations corresponding, for example, with the frame 101, lid 103, ports 107, 108, and 109, gas permeable membrane 105, and impermeable base film 106 will be described in detail below.

1. The Frame

As shown in FIGS. 1 and 2 the frame 101, including cross members 115, comprises a rigid or semi-rigid material selected to form a lightweight, yet durable vessel. The material for the frame 101 may comprise a rigid or semi-rigid thermoplastic material of Flexural Modulus≧700 MPa (ASTM D790, 1 mm/min, 23° C.) such as polyester, polyurethane, polyamide, polysulfone, polyetherimide, polyetheretherketone, polycarbonate, polypropylene homopolymer, polypropylene copolymer, polyethylene homopolymer, polyethylene copolymer, metallocene polypropylene, and metallocene polyethylene. A preferred composition of the frame is polypropylene homopolymer. The material is desirably inert and of a medical grade suitable for contact with blood components for intravenous transfusion. Such materials may be used in combination with external metallized, reduced gas-permeability coatings, or metal laminates to reduce moisture vapor permeability. The frame 101 may be machined from a solid block or, more preferably, may be injection molded in the desired shape and size.

The frame 101 provides the vessel with its rigid structural elements that maintain the vessel integrity and shape during filling, labeling, freezing, freeze-drying, closure, storage, subsequent handling and reconstitution. The frame 101 remains rigid throughout the processing and storage of the material to be freeze-dried and provides overall structural support and attachment sites for other vessel components.

In the preferred embodiment, the frame 101 comprises a rectangular shape of aspect ratio of not more than 1:3 of height vs. length or of height vs. width. The shape allows for efficient thermal transfer through a flat planar base (second broad side 160) of width and length; efficient sublimation of water vapor through an adjacent top surface area (first broad side 150) of similar width and length to the base and equally spaced orthonormal in height from the flat planar base; and the ability to close the top surface area through a lid closure system aligned to the planarity of the first broad side 150 and second broad side 160 of the frame 101. The presence of filling, reconstitution and administration ports on the sides of the vessel shape allows, with appropriate orientation of the shape, for gravitational filling of the vessel with plasma, filling of the vessel with reconstitution fluid and administration of the reconstituted freeze-dried material from the vessel. Preferably, the shape, in addition to its first broad side 150 and second broad side 160, has four side-wall surfaces. Alternative shapes could include more or less than four side-walls which would allow positioning of the administration port 108, with suitable shape orientation at the lowest point of fluid exit. Such alternately shaped devices may have side-walls that provide for a “V-shape,” or a “diamond-shape” appearance and would facilitate gravitational draining of all of the reconstituted material from the device.

As depicted, the frame 101 supports, on its first broad side 150, a gas permeable membrane 105, cross members 115, and a lid 103. In the illustrated embodiments, the gas permeable membrane 105 preferably spans the internal upper skirt rim area 119 of the first broad side 150 and, specifically, the inside open frame area immediately beneath cross members 115. Alternatively, a gas permeable membrane spanning the first broad side 150 external inward peripheral rim 121 of the external top frame surface may be accommodated, but this would need to be at the expense of the air-accessible, semipermeable membrane external of the first broad side 150 area since gasket closure of the device is dependent on unobstructed availability of the flat uninterrupted periphery of the external inward peripheral rim 121. A gas permeable membrane 105 having a surface area close to, or the same as, that of the first broad side 150 surface area is desirable since this provides both a high gas permeable membrane surface area and a shortest pathway for sublimated water vapor to exit device 100 and hence provides for more efficient and more rapid freeze-drying. Preferably, the gas permeable membrane 105 is peripherally sealed or bonded to the interior of frame 101 along the first internal upper skirt rim area 119 underneath cross members 115. Accordingly, the gas permeable membrane 105 is located between the cross members 115 and the interior space 102. Attachment of gas permeable membrane 105 along the first internal upper skirt rim area 119 may be by adhesives or by heat sealing techniques. The cross members 115 provide structural support to the frame 101 and the gas permeable membrane 105. The cross members 115 also define four air permeable quadrants on the first broad side 150 of frame 101 through which gas may be passed into and out of the interior space 102 via the gas permeable membrane 105. The lid 103 is connected to the frame 101 by support stems 140, with support stems 140 being an optional feature of the device since the first base catches 141 and the second base catches 142 may be directly attached or integrally formed as part of the lid 103. The first base catches 141 (and optional second base catches 142) may be spaced regularly around the periphery of the rigid lid 103 which insert into retaining openings 124 (and recesses 125 in the instance that optional second base catches 142 are used) in the frame 101. It is further noted that the optional support stems 140 may be of varying lengths and may not be present. The retaining elements such as base catches and retaining openings may comprise various interlocking elements. In a preferred embodiment, the base catches and retaining openings are of the male/female catch type element. The catch element (male) is generally depicted in this invention disclosure as part of the support stem 140 while the retainer openings 124 (female) to retain the catch are part of the frame. In an alternative embodiment, not depicted, the location of the male elements on the frame or female elements on the lid may also be used. The frame 101 supports, on its second broad side 160, an impermeable base film 106 attached on the surface of outward peripheral base rim 120 of frame 101. The frame 101 is enclosed on its first broad side 150 by the gas permeable membrane 105 and the lid 103, and on its second broad side 160 by the impermeable base film 106. The enclosing frame wall 104 vertically spans the space between the external inward peripheral rim 121 of the first broad side 150 and the outward peripheral base rim 120 of the second broad side 160. Together, the frame 101, lid 103, gas permeable membrane 105, and impermeable base film 106 provide a closed and sealed integrity to the interior space 102.

The cross members 115 on device 100 enhance structural rigidity of the frame 101. Depending on the rigidity and thickness of the material selected for the frame 101, the cross members 115 may or may not be present as part of device 100. For example, if polypropylene material with flexural modulus near 1400 MPa and wall thickness close to or less than 0.100 inch is selected, then the cross members 115 provide needed support to the frame 101.

Present as part of the periphery of frame 101 and within the enclosing frame wall 104 and/or the outward peripheral base rim 120 of the frame, there are retaining openings 124 that correspond in position to regularly spaced support stems 140 and first base catches 141 of lid 103. The retaining openings 124 are shaped so as to mate with the first base catches 141 of lid 103. If optional second base catches 142 on support stems 140 or on lid 103 are employed, then recesses 125 are employed. Reference to both the openings 124 and/or the recesses 125 are made in relation to a preferred invention embodiment, but may also be read to include or comprise any openings, depressions, recesses, indentations, or any other such physical features used to retain the lid 103 in a fixed relationship to the frame 101. In a preferred embodiment, the first base catches 141 are outward facing while the optional second base catches 142 are inward facing (see FIGS. 4A and 4B). Accordingly, once the first base catches 141 and optional second base catches 142 are mated into the retaining openings 124 and recesses 125, respectively, the lid 103 is secured by friction and/or non-slip positional slots. It is noted that the first base catches 141 and retaining openings 124 may comprise an alternative interlocking attachment (as depicted in FIGS. 18, 19A-B, 20A-C, 21A-B, and 22A-B). Non-slip positional slots could provide for insertion of the support stems 140 and first base catches 141 into the retaining openings 124 at one of multiple fixed depth positions such as a first fixed depth position 124a and a second fixed depth position 124b to secure the lid 103 at a height above the air accessible gas permeable membrane 105 of the device 100, such that any further movement of the lid 103 is limited to further unidirectional depression resulting finally in hermetic closure of the lid 103.

In a preferred embodiment, the shape and fitting of the first base catches 141 and optional second base catches 142 into their corresponding retaining openings 124 and optional recesses 125 is designed to ensure that, once engaged, the catches are limited to unidirectional travel. This unidirectional travel ensures that once fitted, the lid cannot be separated from the frame, and that once fully depressed, it remains depressed.

Preferably, the device 100 has at least two fixed positions of the lid 103. FIGS. 3A-B, 4A-B, 19A-B, and 22A-B show a preferred two position closure. The first position would be to fix the lid 103 in an open, membrane-protecting position to enable freeze-drying. The second position would be to fix the lid 103 in its final closed position after freeze-drying. The retaining openings 124 and optional recesses 125 may be depressions of one or more identical or varying depths and/or cut-outs in the enclosing frame wall 104 and/or the exterior upturned rim lip 122 and/or the outward peripheral base rim 120. These cut-outs or depressions can receive interlocking one-way first base catches 141 and optional second base catches 142 attached to the support stems 140 of the lid 103. Accordingly, the present invention provides for the staged unidirectional closure of the lid 103 to accomplish protection of the gas permeable membrane 105 during freeze-drying and to secure closure of the device 100 after freeze-drying is complete.

Also on the underlying surface of lid 103, and as depicted in FIGS. 1, 4A-B, 7, 14, 18, and 22A-B, lid 103 includes a thermoplastic elastomeric closure gasket 114 that is preferably thermally overmolded to the periphery of the top inside surface of the lid 103. The gasket 114 is of typical softness of less than or equal to Shore 50A and the gasket 114 compression set is less than or equal to about 15%. The gasket 114 typically has a glass transition temperature less than about −50° C. The gasket 114 width preferably is between about 0.120 inches and about 0.200 inches wide and between 0.060 inches and 0.100 inches high. Preferably, the longest planar dimension of the gasket 114 (diagonal in the case of a rectangular form, and diameter in the case of a circular form) is greater than about three inches but less than about five and a half inches. Typical compression of the gasket 114 on hermetic full closure of device 100 will be about 50% of the uncompressed gasket height and mean compressed gasket height will be about 0.050 inches. In a particularly preferred embodiment, the assembled fully closed device 100 will have sufficient rigidity to resist flexural displacement of about 1.2% and about 0.7% of length for longest planar dimensions of three inches and five and half inches, respectively, in order for gasket 114 to retain hermetic closure. Gasket 114 is aligned so that when the lid 103 is fully depressed against the frame 101, external inward peripheral rim 121, and with the support stems 140 fully depressed inside recesses 125 and/or openings 124, the gasket 114 is uniformly compressed from between about 30% to about 80% of its original height against the frame 101 and provides closure of the gas permeable membrane 105 and hermetic sealing of the interior space 102 of device 100.

Preferably, the gasket 114 is affixed to the periphery of the top inside surface of the lid 103. Alternatively, however, the gasket 114 can be affixed to the external inward peripheral rim 121 of the first broad side 150 of the frame 101 to engage with the top inside surface of the lid 103 when the lid 103 is depressed against the said alternatively affixed gasket 114.

In the preferred embodiment, in the fully closed state of device 100, the gas permeable membrane 105 is encircled by the compressed gasket 114, and the gasket 114 is encircled and enclosed by the lid 103 in a closed position (with the retaining openings 124 and optional recesses 125 and the first base catches 141 and optional second base catches 142 fully engaged). The retaining openings 124 and first base catches 141 may be within the external inward peripheral rim 121 of the first side surface of the frame 101, or first base catches 141 and optional second base catches 142 and retaining openings 124 and recesses 125 may be within the enclosing frame wall 104 of the frame 101 and/or the exterior upturned rim lip 122, and/or the outward peripheral base rim 120 of the frame 101.

It is preferred that the lid 103 has a molded near perpendicular (near 92° to the planar lid surface, see FIG. 7), overhanging surrounding side wall 131 on all sides of the lid 103. The overhanging surrounding side wall 131 serves both to support the support stems 140 and first base catches 141 and also to provide the lid 103 with additional resistance to bending that might otherwise disrupt the contact of the gasket 114 with either the frame 101 or the lid 103.

In the fully closed condition of the lid 103 against the frame 101, the mated layers provided by the overhanging surrounding side wall 131 of the lid 103 and the enclosing frame wall 104 add significant reinforcement to the device 100 against twisting which might otherwise unseat the hermetic sealing provided by gasket 114 in the fully closed device 100.

As depicted in FIGS. 1-5, 7, 11, 14, 18, 19A, 20A-C, and 22A-B, the retaining openings 124 and recesses 125 on the frame 101 are located around the perimeter of the interior space 102 and form part of either the enclosing frame wall 104, or are located in the exterior upturned rim lip 122, and/or along the outward peripheral base rim 120 on bottom of the frame 101.

In a preferred embodiment, generally as depicted in FIGS. 1-5 and 7, recesses 124 and/or openings 125 are spaced about 0.625 inches from each corner edge of the outward peripheral base rim 120 on the bottom of the frame 101 and are uniformly spaced along each wall of the enclosing frame wall 104, and not more than about 2.5 inches apart and more preferably about 1.75 inches apart. In a preferred embodiment, the device 101 has ten sets of recesses 125 and/or openings 124 that provide points of staged attachment for the lid 103 to the frame 101, with three sets of evenly spaced attachment points each corresponding to the two longer sides of the overhanging surrounding side wall 131 and two sets of attachment points each corresponding to the two shorter sides of the overhanging surrounding side wall 131.

Frame 101 preferably includes an outward peripheral base rim 120 along the periphery of the second broad side 160 surface that is about 0.25 inches wide and has an exterior upturned rim lip 122 that is about 0.375 inches high. The outward peripheral base rim 120 provides a landing onto which the impermeable base film 106 is adhered. Attachment of the impermeable base film 106 to the outward peripheral base rim 120 allows for the impermeable base film 106 to span 100% of the interior space of the second broad side 160 surface of frame component 101. Accordingly, the impermeable base film 106 provides the interface surface between the freeze dryer shelf and the material in the interior space 102 of device 100.

Note that the angle formed by the outward peripheral base rim 120 surface and the vertical enclosing frame wall 104 of the frame 101 is a fixed angle of between about 90° and about 95° (FIG. 7). The preferred angle between the vertical enclosing frame wall 104 of the frame 101 and the outward peripheral base rim 120 surface of the second broad side 160 is 92.5° as this allows for advantages in injection molding removal of the finished frame 101. The preferred angle between external inward peripheral rim 121 surface of the first broad side 150 of the device 100 and the vertical enclosing frame wall 104 of the frame 101 is a fixed angle of about 92.5° (FIG. 7). The exterior upturned rim lip 122 and/or the outward peripheral base rim 120 provides side wall retaining openings 124 positioned to receive the support stems 140 and first base catches 141 of lid 103 and also provides enhanced rigidity to the outward peripheral base rim 120 preventing folding on instances of small positive pressure variances between the outside and inside of the device 100.

In order to promote engagement of the one-way, or unidirectional, first base catches 141 and optional second base catches 142 on support stems 140 of lid 103, raised landings 123, that are about 0.25 inches wide, about one inch long and about 0.025 inches raised from the vertical enclosing frame wall 104, are aligned on the enclosing frame wall 104 immediately opposite the retaining openings 124 located on the exterior upturned rim lip 122 and/or the outward peripheral base rim 120, and may be interposed between optional recesses 125. That is, horizontal recesses 125 may be present on either side of the raised landings 123 to accept one-way directional additional optional second base catches 142 on the inside of the lid 103 and/or support stems 140.

Frame 101 preferably can be between about 4.5 inches to about 5.5 inches long, between about 3.5 inches to about 4.5 inches wide, and between about 0.75 inches to about 1.5 inches high. In a preferred embodiment, frame 101 has a second base side 160 length of about 5.3 inches, and a width of about 4.3 inches, and a vertical height of about 1.30 inches.

As depicted, the frame 101 supports, on its first broad side 150, a gas permeable membrane 105, cross members 115, and a lid 103.

Preferably, the first broad side 150 of frame 101 can have a length between about 4.75 inches to about 5.25 inches and a width between about 3.5 inches to about 4.0 inches. In a particularly preferred embodiment, the first side of frame 101 comprising the cross members 115 has a length of about 4.95 inches and a width of about 3.95 inches. Also in a particularly preferred embodiment, the retaining openings 124 of the frame 101 can allow a depth of travel between about 0.2 inches to about 0.7 inches and a width of travel between about 0.12 inches to about 0.3 inches. In an even more preferred embodiment, the retaining openings 124 of the frame 101 have a depth of travel of about 0.25 inches and a width of travel of support stems 140 of 0.19 inches. Also, in a preferred embodiment, the corner radiuses for the first broad side 150 of frame 101 and second broad side 160 of frame 101 are preferably near 0.625 inches and 0.75 inches, respectively. According to a preferred embodiment, such measurements are optimal for the preparation of plasma up to 250 mL volume in a stable rigid functional container.

Frame 101 can be sized and configured to securely house an electronic tag (not depicted) that can allow for a unique electronic digital signature to be given to each device 100. Such a tag would provide a unique digital signature for each container and provide for a level of digital traceable control of all units during processing into freeze-dried product. Such a unique digital signature could provide for surrogate use of the digital signature during freeze-drying instead of the standard required labeling which could be applied after freeze-drying. Such an electronic tag could be, for example, a Bluechip™ tag.

2. The Lid

The lid 103 is designed to support required traceability labeling for a single donor blood product according to ISBT Code 128, for membrane protection, and staged closure of the device 100.

The lid 103 is made from a rigid thermoplastic gas impermeable material, e.g., polyester, polyurethane, polyamide, polysulfone, polyetherimide, polyetheretherketone, polycarbonate, polypropylene homopolymer, polypropylene copolymer, polyethylene homopolymer, polyethylene copolymer, metallocene polypropylene, and metallocene polyethylene. Such materials may be used in combination with metallized, reduced gas-permeability coatings, or metal laminates to provide enhanced resistance to oxygen and moisture vapor permeability. In the illustrated embodiment, the lid 103 has a planar surface 130 and is made from a generally rigid material. In a preferred embodiment, the lid 103 is made from an injection molded polypropylene homopolymer.

Planar surface 130 of the lid 103 can also provide adequate surface area for placement of a regulatory required label for single donor blood product identification of each device 100, which can then travel with the blood product throughout its processing until the reconstituted freeze-dried material is administered to a subject. In a preferred embodiment, the planar surface 130 of the lid 103 provides the flat, minimum four inch by four inch surface area to permanently attach a traceability label.

A preferred embodiment of the lid has a molded overhanging surrounding side wall 131 of a depth close to one inch extending from all edges of the lid 103. The overhanging surrounding side wall 131 has cut-outs 133 on its two shorter sides to accommodate, on one side the administration port 108 and, on the other side, the reconstitution port 107 and the filling port 109. The overhanging surrounding side wall 131 has cut-outs 132 on its two longer sides that, along with cut-outs 133, allow for unrestricted flow of sublimated ice out of device 100 during freeze-drying. The overhanging surrounding side wall 131 includes the support stems 140 and first base catches 141 and the optional second base catches 142 of lid 103.

The figures show details of the lid 103 and closure system of the device 100 as above described in preferred and alternate embodiments. FIGS. 1, 3A-B, 4A-B, 6A-G, 7, 11, 14-16, 18, 19A-B, 21A-B, and 22A-B show the support stems 140 and first base catches 141 extending from the lid 103 for insertion into the corresponding retaining openings 124 of the frame 101. The preferred support stems 140 and first base catches 141 comprise a unidirectional first base catches 141, a 0.125 inch support stem 140, and an additional optional second base catches 142.

The lid 103 is connected to the frame 101 via support stems 140 and first base catches 141 and optional second base catches 142 which insert into corresponding retaining openings 124 and recesses 125, respectively, of the frame 101 to secure the lid 103 to the frame 101 in one of an initial partially closed condition or a final completely closed condition. In the partially closed condition (FIGS. 3A, 4A, 7, 14, 19A, and 22A), the lid 103 is secured and spaced away from the gas permeable membrane 105, permitting gas and moisture transmission through the gas permeable membrane 105 into or out of interior space 102. In the partially closed condition, the lid 103 is securely connected to the frame 101 during processing, such that the frame 101 and lid 103 can be provided as a single unit and the two cannot be separated. This later condition is a requirement in the ISBT Code 128 labeling and processing of the freeze-dried single donor plasma since the ISBT label is affixed to the lid of device 100 and not to the frame.

To maintain a stable and partially closed condition of the device 100, the support stems 140 with first base catches 141 and optional second base catches 142 of the lid 103 are inserted into the first stop of corresponding retaining openings 124 and recesses 125, respectively, of the frame 101.

A closure force of between about three pound-force per square inch (psi) (206.8 mbar) to ten psi (689.5 mbar) is required to firmly compress the lid 103 and frame 101 together against gasket 114, thus providing for a hermetically closed device 100 wherein the interior space 102 is in a completely closed condition (FIGS. 3B, 4B, 11, 19B, and 22B). This closure force can be actuated by the stoppering mechanism of the freeze-dryer shelves, which generally involves hydraulic loading of one shelf at a time. Final closure provides for a hermetic closure of lid 103 such that the gasket 114 seal is able to withstand a positive or negative pressure difference of at least 300 mbar to standard atmospheric pressure. Accordingly, the device 100 with its integral closure system provides for secure hermetic closure within the confined freeze dryer-controlled environment at near standard atmospheric pressure ensuring a continued dry, essentially or substantially oxygen-free (to less than about 1 ppm O₂), sterile closed condition of the interior space 102 at near atmospheric pressure of the device 100 for secondary packaging and long term storage after removal from the freeze dryer.

In the completely closed condition, the support stems 140 with first base catches 141 and optional second base catches 142 are inserted further into the corresponding retaining openings 124 and recesses 125 of the frame 101 so that the unidirectional first base catches 141 and optional second base catches 142 and support stems 140 are fully inserted into the corresponding retaining openings 124 and recesses 125 of the frame 101, thus bringing the lid 103 into full contact with frame 101 and completely closing and hermetically sealing the device 100. In a preferred embodiment, the entire length of the support stems 140 with the first base catches 141 and optional second base catches 142 of the lid 103 are inserted into the retaining openings 124 and recesses 125 of the frame 101. In the completely closed condition, the lid 103 uniformly compresses the gasket 114 to hermetically seal the entire gas permeable membrane 105 on the first side of the frame 101, completely blocking substantial gas transmission through and sealing these components.

In a preferred embodiment, once the device 100 is in a completely closed condition, it stays closed and prevents moisture and oxygen from entering the device 100 during the time it takes to place the closed device 100 inside a dry, nitrogen-purged, heat-sealed, high efficiency, low moisture vapor transmission rate (MVTR) foil pouch or similar material. Because moisture and oxygen can permeate slowly (over days or months) through pin-hole defects in the metalized surface of the secondary packaging, it is preferable to also include zeolite moisture and oxygen traps inside the secondary foil pouch packaging containing closed device 100.

In both the partially closed position and the completely closed position, the lid 103 protects gas permeable membrane 105. Preferably, the lid 103 can have a length between about 4.75 inches to about 5.5 inches and a width between about 3.5 inches to about 4.5 inches. In a particularly preferred embodiment, the lid 103 has a length of about 5.10 inches and a width of about 4.10 inches. Preferably, the lid 103 and frame 101 are provided as a single unit and the lid 103 provides a label surface for device 100 during sterile transfer of material, freezing, freeze-drying, hermetic closure, application of secondary packaging, storage, reconstitution and administration. In the preferred embodiment, the lid 103 is designed to fit a 4.00 inches by 4.00 inches regulatory required, standard ISBT code 128 label for demonstrating blood product traceability. The ISBT label traceability is securely attached (FIG. 9) to the top planar surface 130 of the device 100's lid 103 just before sterile separation of a thawed FFP single donor source (volume close to 230 ml) unit which has been sterilely connected to the device 100 and from which the plasma has been transferred to device 100. The same single donor traceability information on the FFP unit has now been transferred to device 100. Additionally, or alternatively, some other form of identification such as a digital signature tag can be applied to the device 100 to ensure traceability.

In one embodiment, the planar surface 130 of the lid 103 may include an optional small diameter hole 118 (near 0.10 inches diameter) and a top adhered pull-off sealing cover 117 sealing the hole (FIG. 13). The hole 118 and sealing cover 117 are situated at the end of the planar surface 130 of the lid 103 near ports 107 and 109. The hole 118 may be machined into the cover after injection molding or it may be formed during the injection molding process. If present, the hole 118 is positioned on the lid 103 between the gasket 114 and the ISBT label such that it does not interfere with the function of either. The sealing cover 117 may be a pull-off heat sealed foil material or it may be some other impermeable, heat attachable material. The sealing cover 117 contains a tab end enabling gripping between thumb and forefinger for easy and rapid removal of the tab just before reconstitution. The hole 118, once the sealing cover 117 is removed, allows the rapid exchange of gas out of or into the interior space 102 of device 100 through gas permeable membrane 105 and through the hole 118. Gas would exit from the interior space 102 as the device 100 is being filled with reconstitution fluid. This release of gas from the interior space 102 facilitates rapid filling of device 100 without the need for “burping” air back into the reconstitution fluid bag. Also gas would enter into the device interior space 102 through hole 118 and through the gas permeable membrane 105 as the reconstituted plasma is being administered to a patient.

In the absence of hole 118 or with the hole 118 left sealed by not removing the sealing cover 117, the device 100 can be filled with reconstitution fluid in close to 30 seconds by displacing the inert gas in the interior space 102 of device 100 by gravitational flow and compression of the reconstitution fluid in the reconstitution fluid bag such that the reconstitution fluid is all transferred to device 100 and the inert gas is displaced into the reconstitution fluid bag. An advantage of this transfer, without use of gas escape through the hole 118, is that an inert gas environment is fully maintained inside the interior space 102 of device 100 during reconstitution, and the air transferred into the reconstitution fluid bag subsequently may be used, with secure attachment of the reconstitution fluid bag to the device 100, and the assistance of gravity and under manual compression, in an emergency procedure to provide an enhanced rate of transfusion of reconstituted plasma to an injured person.

3. The Ports and Associated Components

The vessel preferably also includes three port components, reconstitution port 107, administration port 108, and filling port 109 that pass through regions of the frame 101 to provide fluid communication into the interior space 102. In an alternative embodiment not depicted, no administration port 108 is needed because reconstituted material is drained from the device 100 into the reconstituting fluid bag and administered from the reconstituting fluid bag.

As depicted (FIGS. 1, 2, 3A-B, 5A-C and 20A-C) reconstitution port 107 and administration port 108 attach spike ports 170 and 180, respectively. Spike ports 170 and 180 include septums 190, respectively, at either end of a hollow barrel that is 0.75 inches long, 0.16 inches in internal diameter, and 0.25 inches in outer diameter. Typically the septums 190 are positioned 0.3 inches and 0.75 inches inside the hollow barrel away from the enclosing frame wall 104. Alternate positioning of the septum immediately against the frame wall (as depicted in FIGS. 15 and 16) provides the advantage of ensuring no hold-up of material in the spike ports 170 and 180 and thus potential for uneven freezing and non-uniform reconstitution. Such close positioning of the spike port septums 190 against the enclosing frame wall 104 would also enable reduced height of device 100 as depicted in FIG. 16. Twist off caps 171 and 181 at the extremities of both spike ports 170 and 180, respectively, allows access to the interior of the barrel when the material in device 100 is about to be reconstituted or administered. The interior of the spike ports 170 and 180 are sterilized by either gamma irradiation or by ethylene oxide. Spike ports 170 and 180 may be connected to ports 107 and 108 by overmolding or by mechanical close fitting and tie, and/or by close fitting adhesive connection to protruding (close to 0.25 inches) cylindrical flanges from frame 101. The spike ports 170 and 180 are preferably composed of the same thermoplastic material used to mold the frame. The spike ports 170 and 180 may also be prepared from a more flexible and durable thermoplastic material such as ethylene vinyl acetate, polyurethane elastomer, thermoplastic olefin elastomer and/or general thermoplastic elastomer materials.

The advantage of a thermoplastic elastomer spike port is that it can flex when it encounters resistance. This is advantageous when packaging the device 100 in its secondary containment foil pouch packaging that is often vacuum-sealed. An inflexible or unprotected spike port can rupture the vacuum-sealed secondary packaging potentially compromising the long-term shelf stability of the device 100 and its freeze-dried contents. On the other hand, use of a flexible spike port overcomes risk of rupturing/puncturing the secondary packaging by its ability to flex and conform to an enclosed space. Use of a flexible spike port also provides for the advantage of flexing the port in towards the body of device 100 and temporarily fixing the port against the side of device 100. This positioning of the flexible spike port can be used to afford more freeze dryer shelf space when processing multiple units of plasma or it can be used to reduce packaging volume requirements. Use of more rigid material such as polypropylene in the spike ports may require application of soft conforming sleeves over the ends of the spike ports 170 and 180, respectively, before vacuum sealing in the secondary packaging.

As depicted (FIG. 9), filling port 109 attaches to polyvinyl chloride (PVC) transfer tubing 116. The PVC transfer tubing 116 is mechanically attached directly to a molded barb connector on the frame 101 by a BarbLock® retainer. The end of the PVC transfer tubing 116 may be heat-sealed to maintain internal sterility of assembled device 100. The PVC transfer tubing 116 is of sufficient length (about five to twenty inches) to facilitate sterile closure of device 100 after filling of assembled device 100 with plasma by heat sealing of PVC transfer tubing 116. Alternatively, device 100 may be closed sterilely after filling by heat sealing the barb connector directly. The PVC transfer tubing 116 is of sufficient length (about five to twenty inches) to facilitate gravitational transfer of liquid material into the device 100. The PVC transfer tubing 116 is of a sufficient length (about five to twenty inches) to facilitate sterile connection to similar PVC transfer tubing on a source material using a sterile connecting device (STCD). The PVC transfer tubing 116 may attach via a cable tie to a filter. The filter can be a sterile barrier vent filter that facilitates sterilization gas (such as ethylene oxide or autoclave steam) penetration during sterilization.

The reconstitution port 107, administration port 108, and filling port 109 are sealed within regions of the frame 101 and provide fluid communication into the interior space 102. To allow for interior space 102 sterilization and maintenance of sterility, each of reconstitution port 107, administration port 108, and filling port 109 is desirably sealed with a conventional septum or frangible membrane assembly, or by a conventional screw-lock luer fitting, or by conventional heat tube sealing. Each of the reconstitution port 107, administration port 108, and filling port 109 is also sized and configured to be coupled to PVC transfer tubing 116 to enable transfer of materials into and out of the interior space 102.

In a representative arrangement, for example, reconstitution port 107 can be sized and configured, in use, to accommodate introduction of a material in liquid form into the interior space 102 for reconstitution. Reconstitution port 107 also provides a point of attachment of a device hanger clip to allow device 100 containing reconstituted plasma to be suspended optimally from a hanging point for gravitational flow of reconstitution fluid out of administration port 108 during plasma administration to a patient.

Filling port 109 can be sized and configured, in use, to accommodate introduction of a liquid into the interior space 102 for freeze-drying in situ within the device 100.

Administration port 108 can be sized and configured, in use, to accommodate transfer of reconstituted material from the interior space 102.

In the illustrated embodiment, the administration port 108 occupies one shorter side of the enclosing frame wall 104 of the frame 101, while the reconstitution port 107 and the filling port 109 occupy the opposite shorter side of the enclosing frame wall 104 of the frame 101. This separation segregates the port components and their functions, reconstitution port 107 and the filling port 109 dedicated to the plasma filling and reconstitution functions, and the administration port 108 dedicated to the administration function.

As shown in the figures, the reconstitution port 107, administration port 108, and filling port 109 are desirably located in the region of frame 101 located closer to, but below, the gas permeable membrane 105, the external inward peripheral rim 121 of the first broad side 150, and the lid 103. This location is near the top of the first broad side 150 of frame 101 (when seated in an upright horizontal orientation similar to that shown in FIGS. 1 and 2). The reconstitution port 107, administration port 108, and filling port 109 are located so as to permit introduction of the liquid material into the interior space 102 through the filling port 109 with minimal wetting of gas permeable membrane 105. Even with some wetting of gas permeable membrane 105 by plasma, there is low risk of binding of proteinaceous material to gas permeable membrane 105 and affecting permeability in freeze-drying because gas permeable membrane 105 is selected from hydrophobic membrane materials which do not wet and which do not absorb proteinaceous material. In one embodiment, the ports are located between about 0.80 and about 1.20 inches from the bottom provided by the second broad side 160 of frame 101 (when seated in an upright horizontal orientation similar to that shown in FIGS. 1 and 2). In a preferred embodiment, the reconstitution port 107, administration port 108, and filling port 109 are located about 1.00 inches from the bottom provided by the second broad side 160 of frame 101 (when seated in an upright horizontal orientation similar to that shown in FIGS. 1 and 2).

FIG. 11 shows a possible configuration of device 100 whereby a hypodermic syringe may be used to sample liquid aseptically from a device 100 variation through a molded rubber septum in the side of the container. Alternatively, the septum as shown in FIG. 11 may be used to deliver a drug or other agent by hypodermic syringe aseptically into the container.

4. The Gas Permeable Membrane

The material for the gas permeable membrane 105 is selected to be hydrophobic to accommodate the transport of vapors and gases into and out of the interior space 102 during and after the freeze-drying process, but otherwise prevent material from entering or leaving the interior space 102 and does not bind proteinaceous material. The gas permeable material for the gas permeable membrane 105 also allows inert gases to be introduced into the interior space 102 after the freeze-drying process to provide an inert atmosphere within the device 100 conducive to long-term storage of the material.

The gas permeable membrane is preferably supported by a macro-porous (>1 micron porosity) mesh support material that can be melt adhered to the frame 101. The laminate structure of the semipermeable membrane and macroporous support mesh are preferably melt adhered together. The gas permeable membrane 105 allows water vapor to sublimate from material within the interior space 102 during the freeze-drying process and efficiently exit device 100 without creating a pressure difference much greater than positive 500 mTorr between the interior side of gas permeable membrane 105 and the exterior side of gas permeable membrane 105 within the freeze dryer during sublimation.

The preferred laminate structure of gas permeable membrane 105 is comprised of a polyolefin or other mesh support material matched to the composition of the frame 101 material, for example, a polypropylene mesh support material; and a nanoporous semi-permeable hydrophobic membrane material that is composed of nanoporous polytetrafluoroethylene, polyvinylidenefluoride, polyvinylfluoride, polychlorotrifluoroethylene, perfluoroalkoxypolymer, fluorinated ethylene propylene, polyethylenetetrafluoroethylene, polyethylenechlorotrifluoroethylene, perfluorinated elastomer, chlorotrifluoroethylenevinylidene fluoride, perfluoropolyether, siloxane fluoropolymer, general polymeric fluoropolymers, and polymeric hydrophobic nanofiber materials such as nanofiber polypropylene and nanofiber polyethylene.

A thermoplastic mesh support which matches the thermoplastic frame 101 material can be used to integrally melt adhere the gas permeable membrane 105 laminate to the internal upper skirt rim area 119 of the first broad side 150 of frame 101. In this instance, the mesh support is contacted against the frame material under pressure and localized heating is applied by an elevated temperature surface, a dielectric probe, an ultrasonic probe or other type of means of locally melting and intermeshing two molten surfaces together. In the absence of melt adherence of the supported gas permeable membrane 105 laminate to the frame 101, the gas permeable membrane 105 laminate may be glued (e.g., cyanoacrylate glue) and/or mechanically bonded to the frame 101 by compression of the laminate against a gasket seal similar to the 114 gasket used to achieve device 100 hermetic closure.

The integrity of the attached gas permeable membrane 105 and its integrity of attachment to frame 101 can be investigated using standard methods of integrity testing. The integrity of attached gas permeable membrane 105 and fully assembled device 100 absent lid 103 can be validated non-destructively for integrity by non-destructive methods used to validate parenteral sterile filters. Non-destructive testing could include bubble point pressure test, water intrusion test, the aerosol challenge test, pressure decay test and/or diffusive/forward flow test. See Belanger, A. P., et al., Nucl Med Biol 36:955 (2009); Bing, F., et al., PDA J Pharm Sci Technol 44 (2005); Dosmar, M., et al., J Parenter Sci Techno, 46:102 (1992); Newton, D. W., Am J Health Syst Pharm 65:2210, 2212 (2008); Rowe, P., S., et al. Pharm Engineering 16:44 (1996); Schroeder, H. G., PDA J Pharm Sci Technol 57:333 (2003); Tarry, S. W., et al., Ultrapure Water 10:23 (1993).

One example of non-destructive integrity testing of the gas permeable membrane 105 and its attachment to frame 101 is provided, for example, as depicted in FIGS. 23A-C. FIGS. 23A-C show a means of enclosing the gas permeable membrane 105 attached to the frame 101 of device 100. The gas permeable membrane 105 is wetted, typically by an ethanol solution misted uniformly onto the membrane surface. A controlled pressure difference is applied over the wetted membrane to enable interrogation of flow without damaging the membrane. FIGS. 23A-C schematically present how a pressure difference can be applied to the hermetically attached enclosure 200 through gasket 201 to the external inward peripheral rim 121 of frame 101 and also around the enclosed gas permeable membrane 105 attached to the frame 101 of device 100. The non-destructive verification of membrane attachment and its integrity is performed by the detection of pressure changes and gas flow within the cone and/or at port 109. The membrane wetting solution is allowed to evaporate after the testing.

An alternate embodiment of the gas permeable membrane 105 is one in which the gas permeable membrane 105 is adhered integrally and uniformly around its peripheral edge to its own low profile rigid frame support 101a. One such alternate embodiment is depicted, for example, in FIG. 17. The method of adhesion of the membrane or membrane laminate to the rigid frame support 101a may include any of those presented previously (melt, glue, or mechanical adhesion). The gas permeable membrane 105 may be adhered, for example, within a rigid frame support 101a or on an outer surface of a rigid frame support 101a.

Outside of individual testing as an integral part of a closed frame of device 100 such as shown in FIG. 23A-C, each of these framed gas permeable membrane 105 laminates can be individually validated non-destructively for its integrity prior to inclusion in device 100. Such 100% non-destructive testing is performed to validate parenteral sterile filters. (See Belanger, Bing, Dosmar, Newton, Rowe, Schroeder, Tarry, supra). Non-destructive testing could include bubble point pressure test, water intrusion test, the aerosol challenge test, pressure decay test and/or diffusive/forward flow test. The separate low profile rigid support frame would allow for higher assurance attachment of the supported gas permeable membrane 105 laminate to the frame 101 providing for integral attachment with less potential for handling concerns compromising the gas permeable membrane 105 laminate. One embodiment of this low profile rigid framed membrane would be one that is circular in shape, referred to herein as a membrane window, with a diameter just less that the width of the first side of the frame 101 (<4 inches) and with a window whose outer surface is threaded (male) to match with an internal receiving thread (female) on the first broad side 150 of the frame 101, and with a base gasket closure that ensures an integral seal when the membrane window is screwed to the first side of the frame 101 to compress the gasket.

The surface area of the gas permeable membrane 105 and its proximity to the material to be freeze-dried, affect the rate and uniformity of sublimation during the freeze-drying process, i.e., the greater the gas permeable membrane 105 surface area and the closer the proximity and uniformity of coverage of the gas permeable membrane 105, the greater the rate and uniformity of the sublimation. As shown in FIG. 1, the gas permeable membrane 105 is generally rectangular in shape with rounded corners to correspond with, and attach to, the internal upper skirt rim area 119 on the inside of the first broad side 150 of frame 101. Note that the width of the cross members 115 is close to 0.156 inches and, thus, it is expected that the presence of cross members 115 imposes little effect in limiting the rate of sublimation.

Unless the gas permeable membrane system is being used in a sterile International Organization for Standardization (ISO) Class 5 environment or within the confines of sterile isolators, the gas permeable membrane 105 is required to maintain at least a log 6 reduction in bacterial challenge tests (American Society for Testing and Materials, ASTM F1608). Also, the gas permeable membrane 105 preferably maintains resistance to a hydrostatic head of water of at least 150 cm H₂O (American Association of Textile Chemists and Colorists, AATCC TM 127). Preferably, the gas permeable membrane 105 has moisture vapor transmissibility greater than 5000 g/m²/24 hr (Technical Association of the Pulp and Paper Industry, TAPPI T523 23°, 85% RH). Preferably, the gas permeable membrane 105 has a Gurley Hill Porosity less than 20 sec/100 cc (TAPPI T460). Preferably, the gas permeable membrane 105 has relative mean pore size of 0.45 microns or less as determined by the Bubble Point test. Most preferably, the gas permeable membrane has relative mean pore size of 0.20 microns or less as determined by the Bubble Point test. See Bing, Schroeder, Newton supra.

An alternate embodiment of the gas permeable membrane 105 laminate system is a nanoporous membrane material thermally attached to either side of a single macroporous mesh support with the addition of one more layer of base mesh thermally attached to a gas permeable membrane 105. This bilayer gas permeable membrane 105 laminate system is advantageous in a high tolerance venting application in that a single micron sized pin-hole defect in one surface will only penetrate partially through the construct allowing for tolerance of a small number of micro-imperfections in either semi-permeable membrane. The presence of the base layer of thermoplastic macroporous mesh allows for adherence of the gas permeable membrane 105 laminate system to frame 101 of the device 100.

5. The Film

In the illustrated embodiment, impermeable base film 106 is affixed to the outward peripheral base rim 120 on the second broad side 160 of the frame 101. The impermeable base film 106 is peripherally sealed to the second broad side 160 of the frame 101, e.g., by adhesives or heat sealing techniques. The attached impermeable base film 106 is planar and substantially free of folds or imperfections that could adversely affect uniform contact with an underlying planar surface. The impermeable base film 106 is thin (about 0.002 inches to about 0.030 inches thick), flexible (about 100 to about 0.001 MPa, Flexural modulus ASTM D790) to ensure even contact with the freeze dryer shelf, provides good tensile strength (about 10 to about 100 MPa, ASTM D638) and provides resistance to yield (about 3% to about 10%, ASTM D638). The impermeable base film 106 is sufficiently thin and pliable so as to readily conform to the surface upon which it rests at or near −45° C. with a head pressure near 0.7 inches of water. The impermeable base film 106 is desirably transparent, thereby allowing a user to visually inspect the contents of the device 100. The impermeable base film 106 is desirably inert and of medical grade suitable for contact with human plasma. The material for the impermeable base film 106 can comprise, for example, polyethylene film, or polypropylene film, or high-density polyethylene film, or combinations thereof. In a preferred embodiment, polypropylene impact copolymer film is used.

A hard wall cover, not depicted, may be placed over the second broad side 160 of the frame 101 and over the impermeable base film 106 to add additional protection to the impermeable base film 106.

6. Assembly and Qualification of Device 100 for Medical Use

The assembly of device 100 is performed by a contract manufacturer typically under environmentally controlled conditions of ISO Class 8 or better. All components and parts of device 100 are received for final assembly as controlled medical grade parts. Received parts are visually inspected for acceptance in terms of size, integrity, absence of defects, and absence of contaminants. Assembled device 100 lots are subsequently packaged and shipped to the freeze-drying facility for destructive Acceptance Quality Limits (AQL) testing in which 5% to 10% of the manufactured devices 100 are tested for i) resistance to breakage, ii) pyrogen, iii) residual particles, and iv) integrity in an aerosol particle challenge and/or in an aerosol bacterial challenge test. The resistance to breakage test includes dropping the device 100 with its lid 103 fully closed from a two meter height onto a hard, flat, surface and testing for integrity either visually or, more preferably, in the aerosol particle challenge test. Integrity challenge tests are described in the Parenteral Drug Association Report No. 40 (Bing, supra).

Following lot acceptance, the assembled frame and its components of device 100, are sterilized in suitable sterilization packaging with sterilization indicators prior to use. Depending on the presence of fluoropolymer materials in the gas permeable membrane 105 (gamma irradiation being destructive) the assembled device 100 may be sterilized by gamma irradiation, autoclave treatment, or ethylene oxide treatment. The preferred method of sterilization for the preferred embodiments discussed herein is by ethylene oxide sterilization since this produces the least amount of adverse changes in the assembled device 100 and effectively sterilizes the interior space 102 of the device 100 and the inside of the PVC transfer tubing 116. The inside of the spike ports are sterilized either by gamma irradiation (before attachment to device 100) or they are sterilized as part of the device by ethylene oxide treatment.

B. Using the Multifunctional Staged Closure Device

1. Preparation of Material to be Freeze-Dried

In a representative embodiment, the freeze-dried material comprises single donor plasma. A description of an illustrative way of preparing single donor freeze-dried plasma for packaging in a representative device 100 as disclosed in the Figures follows.

Preparation and manufacturing of the plasma will take place in a clean room setting. Depending on the level of bacterial filtration efficiency of the gas permeable membrane 105 and on the integrity of closure of the gas permeable membrane 105 when it is included as part of assembled device 100, the manufacturing and preparation procedures used in preparing freeze-dried plasma can be done, for example, in an ISO Class 8 clean room (or better) in the case of a device 100 with a demonstrated high level of bacterial filtration efficiency (≦log 6 reduction) and demonstrated device 100 closure integrity. When the bacterial filtration efficiency is less effective and/or the device 100 closure integrity has been demonstrated to be less satisfactory, then better environmental controls will be required such as use of ISO Class 5 (or better) clean room facilities or use of sterile isolator technology.

Fresh plasma for transfusion is a product of blood component separation. It is generally collected and prepared by a recognized blood center. It is prepared by centrifugation separation of red blood cells (RBC) and platelets from whole blood donation in pre-screened (HIV, HCV, HBV, HTLV-I, WNV, syphilis) unpaid donors. The plasma is screened for its blood Type whether it be A, B, AB or O, and positive or negative. Screening for low titer anti-B antibody in Type A+ individuals provides an alternative to type AB+ universal plasma that can be transfused to a patient in an emergency without need for blood typing of the patient. Alternatively, universal plasma may be prepared by extraction of the anti-B antibodies from Type A+ plasma by use of immobilized anti-B antigens to which the Type A+ plasma has been exposed. Some blood centers also screen for the presence of human leukocyte antigen (HLA) and human neutrophil antigen (HNA) antibodies whose absence reduces risk of transfusion-related acute lung injury (TRALI). Choice of male donors over female donors also reduces risk of TRALI since female donors are more likely to have HLA and HNA antibodies due to alloantigen exposure during pregnancy. Typically, one unit of fresh plasma accepted for conversion to freeze-dried plasma is close to 250 ml in volume. This type of plasma is termed plasma from pre-screened, single donor whole blood, or simply single donor plasma. In order to ensure stability of the freshly collected single donor plasma, it is frozen to about ≦−18° C. within 8 hours of collection. Once frozen, the single donor plasma is termed FFP. Like all single donor blood products, FFP is tracked throughout its product life by a unique ISBT standardized tracking number. In the United States, FFP is the only U.S. Food and Drug Administration (FDA) approved plasma product for allogeneic transfusion. In contrast to autologous blood donation, allogeneic donation is where the donor and recipient are different individuals.

The FFP intended for preparation of one unit of freeze-dried plasma is stored in a transfer bag at about ≦−18° C. immediately until it is ready for thawing at about 37° C. and its transformation into freeze-dried plasma. The transfer bag is a standard single unit blood bag with an additional sealed pigtail PVC tube for sterile transfer connection to sterile device 100. Typically, a sterile transfer welding device such as Terumo's SCD JIB sterile tubing welder is used to effect a sterile weld of the similar OD/ID sterile PVC tubes from the blood bag and device 100. In the case of device 100 with high bacterial filtration efficiency (≦log 6 reduction) and with integral closure, sterile transfer of the thawed FFP at about 37° C. into device 100 through port 109 is performed at room temperature (20° C.-25° C.) using gravitational flow through the sterilely connected tubing in an ISO class 8 clean room or better. Mass (g) of plasma transferred is determined using a two decimal place digital mass balance. The operators are gowned (hair cover, beard cover, safety glasses, gloves, shoe covers, gown, or overalls) according to the requirements of the controlled environment. ISBT labeling providing traceability of the single donor plasma is secured on the planar surface 130 of the lid 103 before sterile separation of the transfer bag and device 100 by the sterile heat sealing of filling port 109. Tracking of the single donor sample may also be maintained by use of radio-frequency identification (RFID) or Bluechip™ tag approaches.

In an alternate approach to preparation of the FFP for freeze-dried plasma in the blood center, the FFP may be frozen in device 100 having been transferred to device 100 sterilely (via a sterile tube welder connection), without intermediate handling, directly from the centrifuge-separated, non-frozen plasma within about ≦8 hours after collection. The advantage in this alternative approach to preparation of the frozen FFP for the freeze-dried plasma is that the FFP is frozen only once and it is never thawed. This minimizes the loss of the critical coagulation factors on thawing, which is close to about −5% of activity for every thaw cycle that is performed on the plasma. Ideally, the plasma in device 100 would be frozen by placing the sterilely filled and ISBT labeled device 100, with the lid 103 in its first stage (partially closed) position, on a horizontally planar stainless steel plate freezer with shelf temperature maintained at about −45° C. for between about 2 to 8 hours. After freezing, device 100 containing the frozen plasma would be placed inside a heat sealed nitrogen purged bag, stored at a temperature maintained at about ≦−33° C. and transported to the freeze-drying facility for freeze-drying and packaging.

To minimize coagulation factor loss in normal handling (thawing and refreezing), the time between thawing the plasma in its blood-bag, effecting sterile connection, transferring the plasma, and freezing in device should be done expeditiously without delay (typically about 2 hours). Once transferred to device 100, the freezing should be done either on the freeze dryer shelf at about −45° C. or in a separate freezing system by placing the sterilely filled and ISBT labeled device 100, with the lid 103 in its first stage (partially closed) position, on a horizontally planar stainless steel plate freezer with shelf temperature maintained at about −45° C. for between 2 to 8 hours.

2. Freezing and Freeze-Drying the Material

The freeze dryer used for the freezing and freeze-drying may be a validated clean-in-place, steam-in-place freeze dryer attached to an isolator or present in an ISO Class 5 clean room. Preferably, a standard freeze dryer system in an ISO Class 8 environment may be used in the case of a device 100 with demonstrated high level of bacterial filtration efficiency (≦log 6 reduction) and demonstrated device 100 closure integrity.

As indicated in the previous section on preparation of the material, the freezing need not be performed in the same freeze dryer or even within a freeze dryer to achieve the desired freezing results. However, typically freezing and freeze-drying are performed and controlled in the same freeze dryer since this most often allows for reduced handling and higher level of control. By contrast, in the case of the shell freezing which is used to freeze the contents of bottles, this is performed using alcohol/dry-ice baths outside of the freeze dryer.

Freezing of the contents of the material to be freeze-dried is the most important step for controlling structure of the freeze-dried material (cake) and it ultimately determines the rate of freeze-drying and the rate of its reconstitution to a fully soluble liquid.

Freezing of the plasma is performed in the freeze dryer using plate freezing control at about −45° C. The preferred freeze dryer for use with the present invention and clinical development is the Virtis 24 square foot Pilot steam-in-place, clean-in-place lyophilizer with use of a Virtis 5.5 square foot 25EL lyophilizer for preclinical studies.

The device 100 design considerations provide for an initial uniform vertical thermal gradient through the 0.75 inch deep by 3.88 inches wide and 4.88 inches long liquid plasma reservoir, weighing about 217 g, supported immediately against the approximately −45° C. shelf on the thin impermeable base film 106 and retained by the vertical enclosing frame wall 104 of frame 101. Initially, the top surface of the plasma reservoir is about 22° C. while the base of the plasma reservoir is about −45° C.

The frame 101 and lid 103 are composed of polymeric materials that have poor thermal conductivity and hence tend to insulate the inside of device 100 against the cold exterior environment. The thin impermeable base film 106 has good conformability with the stainless steel base freezing shelf, and the film thinness allows for rapid and uniform base cooling of the plasma reservoir from the bottom up and along the direction of the established vertical thermal gradient.

The uniformity, the location of this cooling initiated at the thin impermeable base film 106 and the establishment of a thermal gradient with base temperature at about −45° C. provides for uniform base nucleation of ice crystals in the plasma immediately in contact with the planar (x, y: 0°, 0°) freezing shelf. The nucleated ice subsequently grows preferentially in the z (vertical) direction of the thermal gradient. This results in growth of vertical ice sheets from the thin impermeable base film 106 of the device 100. The formation of crystalline ice is a net transfer of pure water into the growing ice crystal. A consequence of this is that there is an equal and opposite transfer of non-aqueous species to regions immediately adjacent to the vertically growing ice crystals. Competition between adjacent ice crystal nuclei for water and the rate of growth of the ice crystals in the z direction results in regular spacing of the order of hundreds of microns between adjacent ice sheets. As the ice sheets grow, the adjacent space (about 7-10% of the volume) is filled with the non-aqueous protein and salts. Analogous to the nucleation and growth of silver particles in the photographic process, the vertical ice-crystal sheets (about 90-93% of the volume) act as the negative providing for formation of vertical protein/salt sheets. Once the ice sheets have grown from the bottom to the top of the plasma cake, further sitting of the cake for about 2-3 hours at about −45° C. allows for equilibration in diffusion controlled separation processes in the protein and ice layers.

Optimizing of the alternating spacing of negative/positive vertical layers of protein and ice allows for the highly efficient removal of the negative layer by sublimation, and also for rapid reconstitution of the dry positive protein layer immediately prior to transfusion. Non-uniform nucleation, such as nucleation occurring preferentially at an edge, nucleation resulting from uneven contact between the device 101 and the freeze dryer plate shelf, or nucleation resulting from an insufficient thermal gradient in the vertical direction, will cause competing ice structures to form which can substantially retard the drying rate during sublimation and the final reconstitution rate of the plasma cake. This is because the competing ice crystal structures introduce convoluted pathways into the final positive protein layer retarding the removal and re-introduction of water. Hence it is essential that the impermeable base film 106 which forms the base of the plasma reservoir within the interior space 102 of the device 100 contacts the freeze dryer shelf in a uniform and flat manner.

The freeze-drying (sublimation) stage of the processing of lyophilized plasma is performed in primary and secondary drying stages. Primary drying by application of heat under a low-pressure freeze dryer environment (≦300 mTorr) removes substantially all of the crystalline ice by sublimation. Primary drying of plasma with avoidance of plasma collapse is performed with maintenance of drying fronts in the cake at less than about −33° C. while applying heat to the cake. (MacKenzie, A. P., Inter Symposium on Freeze-Drying Biol Products (1976)). Drying fronts occur at any exposed surfaces on the cake. Primary drying is complete when there is a substantial decline in the rate of sublimation due to removal of most of the crystalline ice. Secondary drying is performed with gradual increase from about −33° C. to about −10° C. in the remaining protein cake. This drying step is performed in the absence of any well-defined ice fronts. The slow increase in cake temperature under vacuum near 100 mTorr allows for sublimation of amorphous water that is weakly bound to the salts and protein in the protein cake. Once this water has been substantially removed, the temperature is further ramped to about 25° C. to remove hydrogen bonded water, with final hydrogen bonded water being removed by heating for a short time ≦2 hr at about 40° C. and then dropping quickly back to about 25° C. The lyophilization drying cycle is complete in about three to five days, once the residual moisture in the dried plasma cake is less than about 1% w/w.

During the freezing and freeze-drying process, the device 100 sits on a shelf within a freeze dryer in a horizontal orientation. In this orientation, the gas permeable membrane 105 is on a first broad side 150 of the frame 101, the lid 103 is in the partially closed position, and the impermeable base film 106 contacts the shelf of the freeze dryer. The device 100 undergoes the freezing and freeze-drying process in the freeze dryer with the lid 103 being in the partially closed position, i.e., with the first base catches 141 and optional second base catches 142 inserted into horizontal recesses 125 and/or openings 124 up to the first stage closure point.

In this orientation, during drying, water vapor will sublimate and escape from the material within the device 100 through the gas permeable membrane 105; meanwhile, the lid 103 acts as a protective cover to the gas permeable membrane 105. The frame 101 provides a stable platform of support for the liquid material as it undergoes initial freezing and freeze-drying, keeping the device 100 in this desired orientation. In this orientation, during drying, sublimating water vapor will escape from the material through the gas permeable membrane 105.

3. Introduction of Inert Gas and Completely Closing the Multifunctional Staged Closure Device

At the conclusion of the freeze-drying cycle, the freeze dryer vacuum is opened (by operation of the controller) to an atmosphere of a substantially oxygen-free, high purity inert gas such as nitrogen or argon with oxygen concentration less than about 1 ppm O₂. Carbon dioxide may be used in the make-up of the inert gas, however its use will affect the material's pH balance on reconstitution and this would need to be adjusted for in the citric acid and water reconstitution fluid that is targeted at 3.500±0.125 mM citric acid in the inert gas mixture without carbon dioxide. A blanket of substantially oxygen-free, inert gas enters the interior space of the device 100 through the gas permeable membrane 105, with the lid 103 in the partially closed position, to infiltrate and exclude moisture and oxygen in the interior space 102. While the device 100 (now containing the freeze-dried material) is maintained under the blanket of the oxygen-free, inert gas, the lid 103 is placed into its completely closed position using the automated stoppering mechanism of the freeze dryer.

In a preferred embodiment, the freeze dryer's automated stoppering system pushes the lid 103 and its gasket 114 onto the external inward peripheral rim 121 of the first broad side 150 of the frame 101 with sufficient force such that support stems 140 and the unidirectional catches of the lid 103 are further inserted past the first partial lid closure point to fully engage into their retaining openings 124 and/or recesses 125 of the frame 101, resulting in the device 100 being put into its completely closed condition.

When in a completely closed condition, the device 100 hermetically seals the oxygen-free inert gas environment interior space 102 within the device 100 for subsequent transportation and storage. The resultant exclusion of moisture and oxygen in the presence of the substantially oxygen-free inert gas trapped within the device 100 allows time for final packaging, also under inert gas conditions, and thus prevents degradation of the freeze-dried material carried within the device 100 during subsequent transport and storage.

Non-destructive, rapid verification of device 100's hermetic closure can be implemented either indirectly or directly. Indirect verification of closure and hermetic sealing may be conducted by visual observation that all of the first base catches 141 of the device 100 are firmly seated in their retaining openings 124 and/or recesses 125. Direct verification of hermetic closure may be achieved by inclusion of an inert, rare atmospheric gas such as helium in the container prior to closure within the freeze dryer. Helium may be included alone or it may be a fraction of the dry, oxygen-free gas atmosphere composed substantially of inert gases such as nitrogen or argon used to equilibrate the freeze dryer to external atmospheric prior to closing device 100 and opening to the external atmosphere. Helium is a small molecule that rapidly diffuses through small openings and can be sensitively detected above its ambient atmospheric concentration (5 ppm) using probes attached to a mass spectrometer. Such leak testing using helium has been used previously to demonstrate the presence or absence of leaks from closed pharmaceutical devices or device packaging. See Kirsch, L. E., et al. PDA J Pharm Sci Technol 51:203 (1997); Kirsch, L. E., et al. PDA J Pharm Sci Technol 51:187 (1997); Kirsch, L. E., et al., PDA J Pharm Sci Technol 51:195 (1997); Kossinna, J., et al., Eur J Pharm and Biopharm 75:297 (2010).

4. Further Packaging of the Multifunctional Staged Closure Device

It should be appreciated that in combination with completely closing the lid 100 to achieve hermetic sealing of device 100, a heat-sealed, nitrogen purged (or purged by another inert gas), secondary outer package can be applied over the finally closed device 100 containing the freeze-dried plasma to provide further assurance that the device 100 does not admit moisture or oxygen into the interior space 102 during storage. Ideally, this secondary package should not transmit light. Typically, a foil heat-sealed pouch is applied. The secondary packaging is desirably flexible, containing polyester, plasticized polyvinyl chloride film, or polyethylene film, or polypropylene film, or high-density polyethylene film, or other type of film. Such materials are desirably used in combination with metallized coatings, metal laminates or foils since metallized or foil surfaces have very low transmissibility to water vapor (moisture) and oxygen compared to non-metalized polymer surfaces. Because moisture and oxygen can permeate slowly through pin-hole defects in metalized surfaces, and once inside relatively rapidly (days) permeate through the plastic walls of device 100 inside the low MVTR secondary container (foil pouch), it is preferable to also include zeolite moisture and oxygen traps inside the secondary container with the closed device 100.

Direct verification of secondary package closure may be achieved by inclusion of an inert, rare atmospheric gas such as helium in the secondary packaging prior to heat sealing. Helium may be included alone or it may be a fraction of the dry, oxygen-free gas atmosphere composed substantially of inert gases such as nitrogen or argon. Helium is a small molecule that rapidly diffuses through small openings and can be sensitively detected above its ambient atmospheric concentration (5 ppm) using probes attached to a mass spectrometer. Such leak testing using helium has been used previously to demonstrate the presence or absence of leaks from closed pharmaceutical devices or device packaging. See Kirsch 203, Kirsch 187, Kirsch 195, Kossinna supra.

Further, the device 100 with the lid 103 in a completely closed condition within the secondary packaging also can be placed within a rigid outer container or can with a lid. The outer container provides further protection against tearing, puncturing, or damage of the device 100 during subsequent handling and storage. The outer container or can may comprise, for example, a metal or high impact plastic material. The outer container can, if desired, include additional compartments to hold, along with the closed device 100, a vessel filled with a reconstitution liquid, as well as associated reconstitution and administration sets. The optional outer container or can may include a lid that closes and, desirably, seals the container. The lid may be removed to provide access to the closed device 100 and the optional over wrap at the instance of use.

Optionally, one or more integrity marker elements may be placed within or on the interior of the foil pouch (secondary packaging), or on the exterior of the completely closed device 100. The integrity marker elements would carry a material sensitive to the presence of excessive temperature, oxygen and/or moisture, or combinations thereof, and/or other pre-selected conditions adverse to, or possibly adverse to, the integrity or efficacy of the freeze-dried material. For example, the sensitive material may change color to visibly indicate when a predetermined threshold temperature, level of oxygen and/or moisture, or combination thereof, may have occurred to potentially compromise the efficacy of the plasma. The markers provide further visual indications of the integrity and efficacy of the freeze-dried material within the freeze-dried material storage assembly immediately prior to reconstitution and subsequent administration.

5. Reconstituting and Administering Freeze-Dried Material

For use at a remote site, the device 100 in a completely closed condition is removed from its secondary packaging and/or outer container or can. A transfer set is then coupled to a separate container of sterile reconstituting liquid (e.g., 200 ml of 3.500±0.125 mM citric acid in water for injection). Preferably, the diameter of the tubing in the transfer set is sufficient to permit the rapid reconstitution of the freeze-dried plasma cake. FIG. 10 shows a typical transfer set connection. The transfer set can include plastic needles or spikes at each end to make the coupling. The transfer set may be long and flexible, or may be short and rigid, to reduce storage space and simplify handling. The transfer set may include an injection port to include an active pharmaceutical or an alternate acid to citric such as ascorbic acid. In the case of alternate use of ascorbic acid over citric acid, the ascorbic acid is added to water for injection wherein the final concentration of ascorbic acid when added to the plasma is between about 15 mM and 16 mM.

Connection between device 100 and the reconstitution fluid bag follows clinical standard of care using common luer lock and universal spike connectors. The cap on the male luer is removed, exposing the sterile connector, and the female luer lock on the transfer set is affixed. Once the universal spike on the transfer set is inserted into spike port 170 of reconstitution port 107, the frangible connector on the reconstitution fluid bag is snapped, allowing flow of the reconstitution fluid from the reconstitution fluid bag to device 100.

The caregiver connects device 100 to the container of reconstituting liquid in order to transfer the reconstituting liquid from the reconstitution fluid bag into the device 100. The caregiver can create sufficient fluid pressure across the transfer set by gravity keeping the reconstitution fluid bag higher than receiving device 100 to transfer reconstitution fluid and effect freeze-dried plasma reconstitution to liquid plasma. Because of the design of the system and the preparation and structure of the freeze-dried plasma cake, the reconstitution of plasma using this system is especially rapid and effective.

In one embodiment, the reconstituted material is administered from the device 100. In this arrangement, the administration set used for reconstitution fluid transfer is uncoupled from the reconstitution port 107, and the reconstitution port 107 is closed (the reconstitution port 107 may include a septum that closes upon the removal of the transfer spike or needle). At this time, the caregiver couples the port component 108 to an administration set for transfer of the reconstituted material into the circulatory system of an individual (FIG. 10). The administration set includes a phlebotomy needle for insertion into a vein. In this configuration of device 100, optional hole 118 and sealing cover 117 are required (with seal opened) to allow for gravitational flow of plasma out of administration port 108 without resistance from build-up of vacuum in the interior space 102 of device 100. Compensating in-flow of air through hole 118, through gas permeable membrane 105, and into the interior space 102 of device 100 allows for flow of plasma out of device 100 and through the administration set connected to administration port 108.

Alternatively, the reconstituted material is administered from the original reconstitution bag. In this configuration, the reconstituted material is returned from the device 100 to the reconstitution fluid bag. The transfer set is uncoupled from the reconstitution fluid bag, and the external connection to the transfer port on the reconstitution fluid bag is closed. The caregiver then connects a separate transfer port on the reconstitution fluid bag to a transfusion administration set for transfer of the reconstituted material to a patient. The administration set includes a phlebotomy needle for insertion into a vein, in the same manner as described previously.

In the absence of hole 118 or with the hole left sealed by not removing the sealing cover 117 and with a transfer set tubing having a sufficiently wide diameter, the device 100 can be filled with reconstitution fluid in close to 30 seconds by displacing the inert gas in the interior space 102 of device 100 by gravitational flow and compression of the reconstitution fluid in the reconstitution fluid bag such that the reconstitution fluid is all transferred to device 100 as inert gas from device interior space 102 is displaced into the reconstitution fluid bag. An advantage of this transfer, without use of gas escape through hole 118, is that an inert gas environment is fully maintained inside the interior space 102 of the device 100 during reconstitution, and the inert gas transferred into the reconstitution fluid bag subsequently may be used to provide an enhanced rate of transfusion of reconstituted plasma by manual compression, in an emergency procedure to an injured person. Such manual compression requires secure attachment of the reconstitution fluid bag to the device 100. Alternatively, without manual compression, but with only the assistance of gravity, the gas collected in the flexible reconstitution fluid bag allows for transfer of reconstituted plasma out of device 100 without build-up of any vacuum in device interior space 102.

An alternative method for removal and introduction of sterile gas from the interior space 102 of the device 100 is to use a reconstitution transfer set that includes a vented gas exchange port. In reconstitution, this transfer set allows external venting of the inert gas in the interior space 102 of the device 100. During administration, with the reconstitution transfer set still attached, the vent allows for filling of the interior space 102 of the device 100 with sterilely filtered external air as the plasma is transfused into a patient.

C. Performance Analysis

Use of device 100 to freeze dry FFP under the processing conditions described in this invention disclosure results in a freeze-dried plasma that, when reconstituted, is substantially the same as the original FFP used to prepare the freeze-dried material. This is demonstrated in the comprehensive results of Table 1 that provides mean and standard deviation of results of plasma chemistry testing of paired source FFP and reconstituted freeze-dried plasma for Phase I and Phase II clinical trial device 100 containers. The Phase I and Phase II clinical trial container devices 100 each had a staged closure system as depicted, for example, in FIGS. 1-7. The Phase I clinical trial container device 100 included ports 107 and 108, wherein the single septum ports were placed immediately against the enclosing frame wall 104, and plasma filling was performed aseptically. The Phase II clinical trial container device 100 was sterilely filled with plasma. It is noted that the aseptic plasma filling, as opposed to sterile filling, of the Phase I clinical trial container is not believed to affect the results provided in the following examples. The Phase II clinical trial container device 100 was sterilely filled with plasma.

TABLE 1
Coagulation factor activities and clotting times for Phase I and
Phase II development runs using the device 100

| | | Phase 1 | | Phase 2 | |
|---|---|---|---|---|---|
| | | Development Data | | Development Data | |
| | Clinical | n = 144 | | n = 30 | |
| Test | Ref. | FFP | LyP | FFP | LyP |
| Parameter | Range | Mean | Mean | Mean | Mean |
| PT | 11.0-14.5 | **13.8 ± | 15.2 ± | 13.9 ± | 14.0 ± |
| | sec | 1.0 | 0.8 | 0.8 | 0.7 |
| INR | 0.9-1.1 | **1.1 ± | 1.2 ± 0.1 | 1.1 ± 0.1 | 1.1 ± 0.1 |
| | | 0.1 | | | |
| aPTT | 28.0-40.0 | **32.4 ± | 34.6 ± | 32.0 ± | 34.0 ± |
| | sec | 3.0 | 3.3 | 3.6 | 3.9 |
| Fibrinogen | 200-400 | *313 ± | 302 ± | 273 ± 56 | 294 ± 57 |
| | mg/dL | 54 | 65 | | |
| Factor II | 70-130% | 88 ± 12 | 83 ± 12 | 96 ± 12 | 98 ± 14 |
| Factor V | 70-130% | 94 ± 19 | 86 ± 15 | 86 ± 18 | 89 ± 19 |
| Factor VII\hat{ } | 70-130% | 96 ± 20 | 90 ± 16 | 93 ± 17 | 95 ± 20 |
| Factor VIIa | 0.5-8.4 | 2.7 ± 1.5 | 2.6 ± 1.1 | 1.8 ± 0.7 | 1.7 ± 0.7 |
| | ng/mL | | | | |
| Factor VIII | 50-150% | 102 ± 25 | 92 ± 23 | 104 ± 39 | 115 ± 37 |
| Factor IX\hat{ } | 50-150% | 93 ± 15 | 86 ± 18 | 93 ± 19 | 95 ± 20 |
| Factor X | 70-130% | 95 ± 15 | 95 ± 16 | 94 ± 16 | 93 ± 16 |
| Factor XI\hat{ } | 70-130% | 90 ± 18 | 88 ± 18 | 69 ± 14 | 80 ± 23 |
| vWF antigen | 50-150% | 113 ± 44 | 99 ± 33 | 86 ± 31 | 91 ± 28 |
| Antithrombin\hat{ } | >75% | 93 ± 11 | 93 ± 12 | 86 ± 9 | 89 ± 9 |
| Protein C***\hat{ } | 60-140% | 105 ± 20 | 94 ± 18 | 101 ± 14 | 104 ± 14 |
| Protein S | 70-140% | 94 ± 20 | 89 ± 17 | 109 ± 22 | 112 ± 22 |
| α (2)- | 80-120% | 103 ± 8 | 108 ± | 100 ± 10 | 103 ± 9 |
| Antiplasmin\hat{ } | | | 9 | | |
| Plasminogen | 80-120% | 97 ± 21 | 91 ± 12 | 92 ± 13 | 95 ± 12 |
| Total Protein | 6.0-8.5 | 6.0 ± 0.3 | 5.9 ± 0.3 | 5.9 ± 0.5 | 6.1 ± 0.4 |
| | g/dL | | | | |

*n = 36
**n = 35
***n = 143 for Phase 1 data
\hat{ }n = 29 for Phase 2 data

Table 2 shows the same data as in Table 1 for the Phase II clinical trial container device 100 but also including a column of % difference between paired FFP and lyophilized plasma results.

TABLE 2
Coagulation factor activities and clotting times for FFP and LyP

| | | FFP | LyP | % |
|---|---|---|---|---|
| | Clinical Ref. | n = 30 | n = 30 | Change |
| Test Parameter | Range | Mean | Mean | Mean |
| PT | 11.0-14.5 sec | 13.9 ± | 14.0 ± | 0.9 ± 3.5 |
| | | 0.8 | 0.7 | |
| INR | 0.9-1.1 | 1.1 ± 0.1 | 1.1 ± 0.1 | 1.1 ± 3.9 |
| aPTT | 28.0-40.0 sec | 32.0 ± | 34.0 ± | 6.4 ± 3.1 |
| | | 3.6 | 3.9 | |
| Fibrinogen | 200-400 | 273 ± 56 | 294 ± 57 | 8.3 ± 9.5 |
| | mg/dL | | | |
| Factor II | 70-130% | 96 ± 12 | 98 ± 14 | 1.8 ± 9.7 |
| Factor V | 70-130% | 86 ± 18 | 89 ± 19 | 4.0 ± |
| | | | | 10.9 |
| Factor VII* | 70-130% | 93 ± 17 | 95 ± 20 | 2.1 ± 8.1 |
| Factor VIIa | 0.5-8.4 ng/mL | 1.8 ± 0.7 | 1.7 ± 0.7 | −4.8 ± 9.1 |
| Factor VIII | 50-150% | 104 ± 39 | 115 ± 37 | 13.2 ± |
| | | | | 17.5 |
| Factor IX* | 50-150% | 93 ± 19 | 95 ± 20 | 3.2 ± |
| | | | | 12.1 |
| Factor X | 70-130% | 94 ± 16 | 93 ± 16 | −1.5 ± 6.7 |
| Factor XI* | 70-130% | 69 ± 14 | 80 ± 23 | 15.3 ± |
| | | | | 21.0 |
| vWF Antigen | 50-150% | 86 ± 31 | 91 ± 28 | 9.0 ± |
| | | | | 26.1 |
| Antithrombin* | >75% | 86 ± 9 | 89 ± 9 | 3.1 ± 7.0 |
| Protein C* | 60-140% | 101 ± 14 | 104 ± 14 | 3.9 ± 4.5 |
| Protein S | 70-140% | 109 ± 22 | 112 ± 22 | 3.3 ± 6.0 |
| α (2)- | 80-120% | 100 ± 10 | 103 ± 9 | 2.7 ± 8.7 |
| Antiplasmin* | | | | |
| Plasminogen | 80-120% | 92 ± 13 | 95 ± 12 | 4.4 ± 6.9 |
| D-dimer | ≦256 ng/mL | 138 ± 92 | 144 ± 99 | 3.6 ± |
| | | | | 10.2 |
| PF 1 + 2 | 87-325 pmol/L | 110 ± 56 | 116 ± 60 | 6.0 ± 9.5 |

*n = 29

Table 3 shows moisture, osmolality, pH and reconstitution time for the paired FFP and lyophilized plasma prepared under the processing conditions disclosed herein for the Phase II clinical trial testing using the device 100.

TABLE 3
Moisture, osmolality, pH and reconstitution time for FFP and LyP

| | | FFP | LyP | |
|---|---|---|---|---|
| | Clinical Ref. | n = 30 | n = 30 | % Change |
| Test Parameter | Range | Mean | Mean | Mean |
| Moisture* | ≦1.00% | N/A | 0.93 ± 0.09 | N/A |
| Recon. Time | N/A | N/A | 58 ± 15 | N/A |
| (sec) | | | | |
| pH | 7.0-7.6 | 7.31 ± 0.04 | 7.40 ± 0.06 | N/A |
| Osmolality | 290-320 | 311 ± 7 | 314 ± 7 | 1.0 ± 3.1 |
| | mOsm/kg | | | |

*n = 29

Table 4 shows comparative chemistries between the FFP and its lyophilized plasma of the Phase II clinical trial testing using the device 100 for sodium, potassium, chloride, calcium, albumin and total protein.

TABLE 4
Chemistries for FFP and LyP

| | | FFP | LyP | |
|---|---|---|---|---|
| Test | Clinical Ref. | n = 30 | n = 30 | % Change |
| Parameter | Range | Mean | Mean | Mean |
| Sodium | 135-145 | 162 ± 2 | 167 ± 3 | 3.1 ± 1.7 |
| | mEQ/L | | | |
| Potassium | 3.5-5.2 | 3.1 ± 0.2 | 3.2 ± 0.3 | 3.2 ± 2.2 |
| | mEQ/L | | | |
| Chloride | 97-108 | 100 ± 2 | 104 ± 3 | 4.4 ± 1.4 |
| | mEQ/L | | | |
| Total CO₂ | 18-32 mEQ/L | 20.0 ± 1.6 | 10.1 ± 1.2 | −49.5 ± |
| | | | | 5.4 |
| Calcium | 8.5-10.6 | 7.1 ± 0.4 | 7.3 ± 0.3 | 2.8 ± 3.8 |
| | mg/dL | | | |
| Albumin | 3.2-5.5 g/dL | 3.3 ± 0.3 | 3.4 ± 0.2 | 3.6 ± 5.7 |
| Total | 6.0-8.5 g/dL | 5.9 ± 0.5 | 6.1 ± 0.4 | 3.5 ± 4.8 |
| Protein | | | | |
| C3a | 71-590 ng/mL | 156 ± 58 | 213 ± 123 | 39.7 ± |
| | | | | 58.3 |

Tables 1 to 4 show chemical comparisons between FFP and its lyophilized plasma for FFP that is substantially less than 12 months old (non-expired FFP stored at ≦−18° C.).

Table 5 shows the stability results of freeze-dried plasma stored in Phase II clinical trial devices 100 at 2° C. to 8° C. for 12 months.

TABLE 5
Stability of LyP Stored at 2° C.-8° C. at 0 and 12 Months

| | Clinical Ref. | T0 | T12 | % |
|---|---|---|---|---|
| Test Parameter | Range | n = 15 | n = 13 | Change |
| Moisture, % | ≦1.00% | 0.87 ± | 0.85 ± | −1.9 |
| | | 0.05 | 0.10 | |
| Reconstitution | N/A | <2 | <2 | n/a |
| time, min. | | | | |
| pH | 7.0-7.6 | 7.37 ± 0.07 | 7.42 ± | n/a |
| | | | 0.09 | |
| Osmolality | 290-320 | 306 ± 4 | 309 ± 10 | 1.1 |
| | mOsm/kg | | | |
| PT | 11-14.5 sec. | 14.7 ± 0.7 | 14.4 ± 0.7 | −2.1 |
| INR | 0.9-1.1 | 1.2 ± 0.1 | 1.1 ± 0.1 | −5.7 |
| aPTT | 28.0-40.0 sec. | 33.9 ± 2.2 | 33.9 ± 2.7 | 0 |
| Fibrinogen | 200-400 | n/a | 324 ± 66 | n/a |
| | mg/dL | | | |
| Factor V | 70-130% | 88 ± 18 | 79 ± 11 | −9.9 |
| Factor VIIa | 0.5-8.4 ng/mL | 1.9 ± 0.6 | 2.8 ± 1.1 | 50.2 |
| Factor VIII | 50-150% | 103 ± 37 | 89 ± 30 | −13.9 |
| Factor XI | 50-150% | 81 ± 19 | n/a | n/a |
| Antithrombin | >75% | 96 ± 7 | 77 ± 12 | −20.2 |
| Protein C | 70-130% | 101 ± 21 | n/a | n/a |
| Protein S | 70-140% | 97 ± 14 | 109 ± 16 | 12.1 |
| PF 1 + 2 | 87-325 | 159 ± 57 | 133 ± 35 | −16.4 |
| | pMol/L | | | |
| Total Protein | 6.0-8.5 g/dL | 5.9 ± 0.3 | 6.0 ± 0.3 | 1.5 |

Device 100 tested for 12 months stability at 2° C. to 8° C. for Phase II clinical trials demonstrated that freeze-dried plasma demonstrates minimal changes in chemistry after 12 months of storage as shown in Table 5. It is notable from Table 5 that device 100 with its closure system allows for excellent control of moisture. The enhanced atmospheric control possible within the lyophilizer using device 100 and the excellent moisture control as demonstrated by the results of Table 5 may provide for further enhancement of stability with processing in device 100 and storage over 5 years or more at 2° C. to 8° C. refrigeration conditions. Such an ability to store a blood product is highly desirable especially where national stockpiling is currently not possible due to the shortcomings of current low temperature storage requirements for plasma and other blood products. The results of Table 5 are corroborated by the results of stability testing of 13 month old Phase II freeze-dried plasma as shown in Table 6.

TABLE 6
Comparison of FFP aged 13 months and paired LyP at T0

| | Clinical Ref. | FFP | LyP | |
|---|---|---|---|---|
| Test Parameter | Range | N = 6 | n = 6 | % Change |
| Moisture, % | ≦1.00% | n/a | 0.91 ± 0.03 | n/a |
| Reconstitution | N/A | n/a | <2 | n/a |
| time, min. | | | | |
| pH | 7.0-7.6 | 7.30 ± 0.04 | 7.39 ± 0.06 | n/a |
| Osmolality | 290-320 | 313 ± 5 | 310 ± 7 | −0.2 |
| | mOsm/kg | | | |
| PT | 11-14.5 sec. | 14.4 ± 0.7 | 14.4 ± 0.7 | 0.0 |
| INR | 0.9-1.1 | 1.1 ± 0.1 | 1.1 ± 0.1 | 0.0 |
| aPTT | 28.0-40.0 sec. | 30.7 ± 4.2 | 31.2 ± 2.9 | 0.4 |
| Fibrinogen | 200-400 | 253 ± 45 | 266 ± 49 | 1.3 |
| | mg/dL | | | |
| Factor V | 70-130% | 84 ± 13 | 88 ± 14 | 1.2 |
| Factor VIIa | 0.5-8.4 ng/mL | 2.2 ± 1.4 | 2.0 ± 1.2 | −3.0 |
| Factor VIII | 50-150% | 98 ± 29 | 112 ± 35 | 3.3 |
| Antithrombin | >75% | 96 ± 7 | 98 ± 5 | 0.5 |
| Protein S | 70-140% | 97 ± 20 | 101 ± 19 | 1.0 |
| Plasminogen | 80-120% | 89 ± 7 | 92 ± 7 | 0.8 |
| D-dimer | ≦256 ng/mL | 168 ± 75 | 173 ± 64 | 0.7 |
| Total Protein | 6.0-8.5 g/dL | 5.8 ± 0.4 | 6.0 ± 0.4 | 0.8 |

The chemistries shown in Table 6 are between aged FFP (13 months storage at ≦−18° C.) and its paired lyophilized plasma prepared as verification that FFP age does not affect the resultant lyophilized product. The minimal changes demonstrated in Table 6 provide further assurance that processing of FFP in device 100, results in a reconstituted lyophilized product that is substantially the same as the source FFP.

Use of device 100 accommodates long term storage, e.g., at least one year at room temperature 20° C.-25° C., and at least two years at about 2° C. to 8° C. and likely beyond 5 years while the freeze-dried material retains its coagulation factor activity and the ease of reconstitution necessary for safe and efficacious transfusion.

The results of Table 6 are corroborated by the results of 11 months of stability testing of 13 month old Phase II freeze-dried plasma as shown in Table 7.

TABLE 7
Stability of LyP manufactured from FFP aged 13 months and stored at
2° C. to 8° C. at 0 and 11 months

| Test | Ref. | T0 (n = 6) | | T11 (n = 6) | |
|---|---|---|---|---|---|
| Parameter | Range | FFP | LyP | FFP | LyP |
| Moisture, % | ≦1.00% | n/a | 0.91 ± | n/a | 0.96 ± |
| | | | 0.03 | | 0.23 |
| Reconstitution | N/A | n/a | <2 | n/a | <2 |
| time, min. | | | | | |
| pH | 7.0-7.6 | 7.30 ± | 7.39 ± | 7.31 ± | 7.48 ± |
| | | 0.04 | 0.06 | 0.03 | 0.06 |
| Osmolality | 290-320 | 313 ± 5 | 310 ± 7 | 317 ± 4 | 309 ± 4 |
| | mOsm/kg | | | | |
| PT | 11-14.5 | 14.4 ± 0.7 | 14.4 ± 0.7 | 13.5 ± 0.6 | 14.1 ± |
| | sec. | | | | 0.8 |
| INR | 0.9-1.1 | 1.1 ± 0.1 | 1.1 ± 0.1 | 1.0 ± 0.1 | 1.1 ± 0.1 |
| aPTT | 28.0-40.0 | 30.7 ± 4.2 | 31.2 ± 2.9 | 33.5 ± 6.53 | 6.6 ± 6.9 |
| | sec. | | | | |
| Fibrinogen | 200-400 | 253 ± 45 | 266 ± 49 | 356 ± 84 | 395 ± 94 |
| | mg/dL | | | | |
| Factor V | 70-130% | 84 ± 13 | 88 ± 14 | 89 ± 21 | 89 ± 18 |
| Factor VIIa | 0.5-8.4 | 2.2 ± 1.4 | 2.0 ± 1.2 | 1.9 ± 0.8 | 2.0 ± 0.8 |
| | ng/mL | | | | |
| Factor VIII | 50-150% | 98 ± 29 | 112 ± 35 | 102 ± 55 | 98 ± 54 |
| Antithrombin | >75% | 96 ± 7 | 98 ± 5 | 91 ± 11 | 91 ± 8 |
| Protein S | 70-140% | 97 ± 20 | 101 ± 19 | 112 ± 20 | 116 ± 20 |
| Plasminogen | 80-120% | 89 ± 7 | 92 ± 7 | 104 ± 15 | 105 ± 14 |
| D-dimer | ≦256 | 168 ± 75 | 173 ± 64 | 127 ± 27 | 124 ± 23 |
| | ng/mL | | | | |
| Total Protein | 6.0-8.5 | 5.8 ± 0.4 | 6.0 ± 0.4 | 6.0 ± 0.3 | 6.2 ± 0.3 |
| | g/dL | | | | |

Tables 8A and B and FIGS. 24A to 24I show the results of stability testing of lyophilized plasma prepared in device 100 (Phase I clinical container), fully stoppered, packaged in secondary foil packaging and stored at controlled temperature conditions of either 2° C.-8° C. (4C) or 23° C. (RT) for 0, 2, 4, 6, 9, 12, 19, 24, and 36 months. Each time point for 2° C.-8° C. depicts an average of 13 different FFP units in 13 different packaged device 100 containers. Each time point for 23° C. depicts an average of three different FFP units in three different packaged device 100 containers. Error bars in FIGS. 24A-24I represent one standard deviation. Testing at the different time points for both temperature conditions is shown in FIGS. 24A-24I for A) % w/w residual moisture in the lyophilized plasma; B) Prothrombin time (PT); C) Partial thromboplastin time (aPTT); D) Factor V % activity; E) Factor VIII % activity, F) Factor VIIa % activity, G) Protein S % activity; H) Antithrombin III % activity; and I) Total Protein (g/dL). Tables 8A and 8B tabulate the FIGS. 24A-24I stability data results (DB PT=Prothrombin time; AT=Antithrombin III) as well as the additional data results for pH, osmolality, INR (DB INR), Fibrinogen (FB), D-Dimes, and Prothrombin Fragment (PF 1.2). Individual testing at the different time points for both temperature conditions was performed for A) % w/w residual moisture in the lyophilized plasma; B) Prothrombin time; C) Partial thromboplastin time; D) Factor V; E) Factor VIII, F) Factor VIIa, G) Protein S; H) Antithrombin III; and I) Total Protein.

The results demonstrate the ability of the freeze-drying processing described in this invention disclosure and use of device 100 in combination with secondary foil packaging to provide for substantial preservation of the plasma up to and beyond 3 years in the case of plasma stored at 2° C. to 8° C. and of at least up to 2 years in the case of plasma stored at room temperature. This creates a substantial opportunity to include a blood product in the U.S. national stockpile for the first time. The primary indicators for stability are the activities of Factors V and VIII since these are the most labile Factors of the coagulation factors in plasma. It can be seen from Table 8A and FIGS. 24D and 24E that loss of activity of Factors V and VIII at refrigeration over 36 months is not much more than 20% of the original activities of both these Factors. Given the length of time of storage, this change is relatively small and provides confidence that the controls of maintaining low moisture and oxygen in the processing and lyophilized storage of plasma is a highly successful stratagem. The excellent stability of the labile Factors is reflected in the minimal change in both PT and aPTT clotting tests and the stability in the anti-clotting Factors Protein S and Antithrombin III. The loss in activity by close to 50% over 2 years of Factor V and Factor VIII in the case of room temperature storage of lyophilized plasma is a reasonable indicator that 2 years storage at 23° C. is likely acceptable for this product. In the case of extended storage beyond 1 year, refrigeration storage of the lyophilized plasma would be the preferable mode of storage.

TABLE 8A
1. Stability testing results of LyP aged for 0, 2, 4, 6, 9, 12, 19, 24 and 36
months and stored at 2° C. to 8° C. (4 C.).

| | T = 0 | | T = 2 | | T = 4 | | T = 6 | |
|---|---|---|---|---|---|---|---|---|
| 4 C. | Avg. | Stdev | Avg. | Stdev | Avg. | Stdev | Avg. | Stdev |
| pH | 7.37 | 0.07 | 7.42 | 0.06 | 7.37 | 0.07 | 7.42 | 0.05 |
| Osmolality | 306 | 4 | 310 | 8 | 305 | 7 | 308 | 4 |
| DB PT | 13.9 | 1.5 | 13.6 | 0.9 | 14.0 | 1.6 | 13.1 | 0.9 |
| DB INR | 1.2 | 0.1 | 1.1 | 0.1 | 1.2 | 0.2 | 1.1 | 0.1 |
| aPTT | 33.9 | 2.2 | 33.4 | 2.6 | 36.4 | 3.2 | 33.6 | 3.5 |
| FIB | n/a | n/a | 316 | 74 | 302 | 73 | 319 | 54 |
| F. V | 88 | 18 | 82 | 19 | 94 | 26 | 78 | 16 |
| F. VIIa | 1.88 | 0.63 | 2.31 | 1.45 | 2.26 | 1.0 | 3.1 | 1.3 |
| F. VIII | 103 | 37 | 100 | 27 | 115 | 37 | 107 | 33 |
| AT | 96 | 7 | 97 | 11 | 93 | 12 | 105 | 15 |
| Protein S | 97 | 14 | 105 | 24 | 97 | 14 | 97 | 15 |
| D-dimer | 138.1 | 41.9 | 131.9 | 35.3 | 234.1 | 177.6 | 179.2 | 47.8 |
| PF 1.2 | 171 | 51 | 146 | 46 | 199 | 166 | 163.0 | 86.0 |
| Total Protein | 5.9 | 0.3 | 5.9 | 0.4 | 6 | 0.3 | 6.0 | 0.4 |
| % Moisture | 0.87 | 0.05 | 0.89 | 0.07 | 0.88 | 0.05 | 0.88 | 0.08 |

2. Stability testing results of LyP aged for 0, 2, 4, 6, 9, 12, 19, 24 and 36
months and stored at 2° C. to 8° C. (4 C.).

| T = 9 | | T = 12 | | T = 19 | | T = 24 | | T = 36 | |
|---|---|---|---|---|---|---|---|---|---|
| Avg. | Stdev | Avg. | Stdev | Avg. | Stdev | Avg. | Stdev | Avg. | Stdev |
| 7.43 | 0.07 | 7.42 | 0.09 | 7.41 | 0.09 | 7.44 | 0.07 | 7.52 | 0.09 |
| 309 | 7 | 309 | 10 | 311 | 4 | 305 | 4 | 304 | 8 |
| 14.7 | 1.0 | 14.4 | 0.7 | 14.8 | 0.7 | 15.2 | 0.7 | 15.4 | 0.9 |
| 1.1 | 0.1 | 1.1 | 0.1 | 1.1 | 0.10 | 1.20 | 0.1 | 1.12 | 0.07 |
| 36.6 | 3.8 | 33.9 | 2.7 | 36.2 | 4.8 | 35.1 | 2.2 | 36.1 | 3.1 |
| 306 | 49 | 324 | 66 | 349 | 62 | 338 | 97 | 317 | 84 |
| 71 | 17 | 79 | 11 | 84 | 17 | 80 | 13 | 70 | 9 |
| 2.3 | 1.3 | 2.9 | 1.1 | 1.4 | 0.7 | 1.2 | 0.32 | 1.5 | 0.6 |
| 77 | 19 | 89 | 30 | 93 | 45 | 104 | 44 | 82 | 35 |
| 103 | 19 | 77 | 12 | 91 | 8 | 87 | 14 | 87 | 5 |
| 95 | 12 | 109 | 16 | 95 | 15 | 96 | 18 | 99 | 17 |
| 147.6 | 57.9 | 168.7 | 68.4 | 179.4 | 138.0 | 243.0 | 208.0 | 127.8 | 33.8 |
| n/a | n/a | 133.0 | 35.0 | n/a | n/a | n/a | n/a | n/a | n/a |
| 6.0 | 0.4 | 6.0 | 0.3 | 5.9 | 0.3 | 5.9 | 0.4 | 6.0 | 0.3 |
| 0.84 | 0.05 | 0.85 | 0.10 | 0.89 | 0.12 | 1.13 | 0.09 | 0.94 | 0.06 |

TABLE 8B
1. Stability testing results of LyP aged for 0, 2, 4, 6, 9, 12, 19, 24 and 36
months and stored at 23° C. (RT).

| | T = 0 | | T = 2 | | T = 4 | | T = 6 | |
|---|---|---|---|---|---|---|---|---|
| RT | Avg. | Stdev | Avg. | Stdev | Avg. | Stdev | Avg. | Stdev |
| pH | 7.37 | 0.07 | 7.50 | 0.04 | 7.48 | 0.18 | 7.49 | 0.10 |
| Osmolality | 306 | 4 | 302 | 2 | 299 | 2 | 308 | 5 |
| DB PT | 13.9 | 1.5 | 15.7 | 1.4 | 16.7 | 0.7 | 16.4 | 0.7 |
| DB INR | 1.2 | 0.1 | 1.3 | 0.2 | 1.4 | 0.1 | 1.5 | 0.0 |
| aPTT | 33.9 | 2.2 | 40.2 | 1.3 | 41.1 | 1.7 | 41.1 | 1.4 |
| FIB | n/a | n/a | 323 | 111 | 248 | 55 | 275 | 51 |
| F. V | 88 | 18 | 66 | 12 | 66 | 5 | 70 | 10 |
| F. VIIa | 1.88 | 0.63 | 1.57 | 0.59 | 1.60 | 0.45 | 2.65 | 0.68 |
| F. VIII | 103 | 37 | 65 | 16 | 81 | 29 | 62 | 23 |
| AT | 96 | 7 | 99 | 91 | 89 | 2 | 84 | 10 |
| Protein S | 97 | 14 | 95 | 34 | 100 | 15 | 79 | 29 |
| D-dimer | 138.1 | 41.9 | 124.7 | 21.3 | 162.8 | 91.5 | 133.3 | 40.4 |
| PF1.2 | 171 | 51 | 135 | 31 | 127 | 27 | 128 | 43 |
| Total Protein | 5.9 | 0.3 | 5.8 | 0.3 | 5.6 | 0.3 | 6.2 | 0.2 |
| % Moisture | 0.87 | 0.05 | 0.96 | 0.03 | 0.91 | 0.04 | 0.84 | 0.02 |

2. Stability of LyP manufactured from FFP aged 0, 2, 4, 6, 9, 12, 19, 24
& 36 months and stored at 23° C. (RT).

| T = 9 | | T = 12 | | T = 19 | | T = 24 | | T = 36 | |
|---|---|---|---|---|---|---|---|---|---|
| Avg. | Stdev | Avg. | Stdev | Avg. | Stdev | Avg. | Stdev | Avg. | Stdev |
| 7.50 | 0.10 | 7.52 | 0.09 | 7.43 | 0.05 | 7.34 | 0.2 | 7.48 | 0.16 |
| 299 | 9 | 305 | 10 | 297 | 5 | 305 | 3 | 298 | 5 |
| 18.6 | 1.4 | 22.2 | 1.7 | 20.4 | 3.0 | 20.8 | 1.9 | 31.6 | 7.0 |
| 1.4 | 0.1 | 1.7 | 0.1 | 1.7 | 0.3 | 1.7 | 0.2 | 2.3 | 0.5 |
| 44.9 | 2.9 | 57.4 | 18.4 | 56.7 | 11.01 | 50.7 | 7.2 | 73.6 | 11.9 |
| 198 | 50 | 181 | 49 | 172 | 21.2 | 196 | 13 | 136 | 53 |
| 44 | 8 | 44 | 13 | 42 | 13 | 56 | 9 | 31 | 14 |
| 2.13 | 0.70 | 1.60 | 0.43 | 0.98 | 0.29 | 1.07 | 0.35 | 0.47 | 0.15 |
| 49 | 8 | 41 | 13 | 50 | 18 | 49 | 15 | 30 | 3 |
| 78 | 7 | 55 | 10 | 61 | 1 | 73 | 8 | 58 | 7 |
| 84 | 12 | 61 | 6 | 66 | 11 | 69 | 14 | 66 | 12 |
| 108.2 | 29.7 | 125.2 | 58.0 | 203.4 | 58.0 | 120.0 | 17.2 | 110.0 | 0.0 |
| n/a | n/a | 144 | 40 | n/a | n/a | n/a | n/a | n/a | n/a |
| 5.6 | 0.4 | 5.6 | 0.4 | 5.8 | 0.4 | 5.8 | 0.2 | 5.9 | 0.3 |
| 0.96 | 0.1 | 0.94 | 0.03 | 0.92 | 0.07 | 1.11 | 0.11 | 0.94 | 0.20 |

The Phase II clinical trial container device 100 was also subjected to integrity testing.

Integrity test results of device 100 in Phase II clinical testing are summarized as follows: 60/60 LCP passed visual verification; 60/60 LCP passed optical testing; 15/15 LCP that were not pre-stressed passed aerosolized particle testing; 29/30 LCP that were pre-stressed passed aerosolized particle testing (one container had a filtration efficiency of <99.999%); 29/30 LCP pre-stressed containers passed dye penetration testing at 1 in Hg vacuum pressures (the dye penetration test confirmed the defect in the container with lower filtration efficiency and demonstrated the failure point to be on one of the overmolded spike ports—the overmold issue (seal integrity) was resolved by application of increased pressure to the molten polypropylene shot); 30/30 LCP pre-stressed containers passed process simulation testing/media challenge (post incubation media was tested and passed the growth promotion test).

The LCP integrity testing data demonstrated container closure integrity in 59 of 60 LCP development containers that were pre-stressed and tested. The testing program was able to detect a failure in one container, indirectly serving as a negative control, with the aerosolized particle test and the dye penetration test.

1. A multifunctional lyophilization device comprising:
a staged closure lid;
a frame;
a gas permeable membrane; and
an impermeable film.

2. The device of claim 1, wherein the gas permeable membrane is supported on a first broad side of the frame and the impermeable film is supported on a second broad side of the frame.

3. The device of claim 1, wherein the staged closure lid is unidirectional and includes at least one of a base catch and a retaining opening, and wherein the frame includes at least one of a base catch and a retaining opening.

4. The device of claim 3, wherein at least one base catch on one of the unidirectional staged closure lid and the frame, and the at least one retaining opening on one of the unidirectional staged closure lid and the frame, mate at one of multiple fixed positions.

5. The device of claim 4, wherein the at least one base catch and the at least one retaining opening mate at a first fixed position to secure the unidirectional staged closure lid at a height above and spaced away from the gas permeable membrane.

6. The device of claim 4, wherein the at least one base catch and the at least one retaining opening mate at a second fixed position to fully close and uniformly seal the unidirectional staged closure lid to the first broad side of the frame.

7. The device of claim 4, wherein at least one base catch is located on a peripheral edge of the unidirectional staged closure lid and at least one retaining opening is located on a peripheral edge of the frame.

8. The device of claim 2, wherein the frame, the gas permeable membrane, and the impermeable film enclose an interior space.

9. The device of claim 2, wherein the impermeable film is integrally attached on a surface of an outward peripheral base rim of the second broad side of the frame.

10. The device of claim 2, wherein the gas permeable membrane is integrally attached to one of a surface of the frame and a separate rigid frame support.

11. The device of claim 1, wherein the staged closure lid further includes an overhanging surrounding side wall, and wherein the overhanging surrounding side wall further includes cut-outs.

12. The device of claim 1, further comprising at least one of a gasket, a port, and a secondary closure system.

13. A staged shelf stoppered closure system for freezing, freeze-drying, and sealing freeze-dried biological material within a freeze dryer comprising:
a biological material;
a unidirectional staged closure lid;
a frame that peripherally encircles an interior space;
a gas permeable membrane; and
an impermeable film.

14. The system of claim 13, wherein the biological material is human plasma and the device is in a partially closed configuration for freezing and freeze-drying.

15. The system of claim 13, wherein the biological material is human plasma and the device is in a fully closed configuration for sealing.

16. A method of using a multifunctional lyophilization device comprising a unidirectional staged closure lid and a gas permeable membrane to prepare and preserve a biological material comprising:
freezing, freeze-drying, and sealing the biological material within a shelf stoppering freeze dryer.

17. The method of claim 16, further comprising:
freezing and freeze-drying the biological material while the staged closure lid is in a partially closed configuration and spaced away from the gas permeable membrane;
permitting water to sublimate through the gas permeable membrane during freeze-drying;
introducing a gas other than oxygen into the device; and
reducing the water content of the biological material to less than about 1% (w/w).

18. The method of claim 17, further comprising
using the shelf stoppering freeze dryer to move the staged closure lid into a fully closed configuration; and
sealing the freeze-dried biological material.

19. The method of claim 18, further comprising storing the freeze-dried biological material within the device for at least about two years at 2° C. to 8° C., and wherein the biological material is human plasma.

20. The method of claim 19, further comprising substantially preserving the human plasma and reconstituting the substantially preserved human plasma in less than about two minutes.
